(19) United States
(12) Patent Application Publication
(10) Pub. No.: US 2026/0289356 A1
(43) Pub. Date: Sep. 24, 2026

(54) SYSTEM

(71) Applicant: SoftBank Group Corp., Tokyo (JP)

(72) Inventor: Kazuya NAKASHIMA, Tokyo (JP)

(73) Assignee: SoftBank Group Corp., Tokyo (JP)

(21) Appl. No.: 19/565,617

(22) Filed: Mar. 13, 2026

(30) Foreign Application Priority Data
Mar. 19, 2025 (JP) 2025-045152

(51) Int. Cl. G06N 5/046

(52) U.S. Cl. CPC G06N 5/046

(57) ABSTRACT

A system includes a processor that is configured to analyze big data and process data using a generative artificial intelligence model that extracts variable factors, input generated variable factors into the generative artificial intelligence model as a prompt sentence, and recognize an emotional state of a user and adjust a prediction based on the emotional state of the user.

### CROSS-REFERENCE TO RELATED APPLICATION

This application is based on and claims priority under 35 USC 119 from Japanese Patent Application No. 2025-045152 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional workload prediction systems using statistical models or machine learning techniques typically analyze big data to estimate future workload volumes, peak times, and related operational parameters. However, such systems generally treat all input and output interactions with users as neutral and ignore the emotional state of the user. As a result, conventional systems may generate predictions or recommendations that are technically accurate with respect to historical data but are perceived as inappropriate, overly optimistic, overly conservative, or insufficiently reassuring from the user’s emotional perspective. This mismatch can lead to reduced user trust, suboptimal decision-making, and reluctance to rely on automated predictions in critical business contexts.

Furthermore, existing generative artificial intelligence models are often used to produce text or responses based on prompts derived from static or pre-defined factors, and they typically do not dynamically extract and reuse variable factors from big data as structured prompts tailored to specific prediction tasks. Consequently, these systems may fail to capture complex, latent relationships in big data in a form that is optimized for downstream predictive processing.

In addition, there remains a technical challenge in integrating variable factor extraction from big data, prompt generation for a generative artificial intelligence model, and emotional state recognition of the user into a unified system. Without such integration, it is difficult to both leverage the expressive power of generative models and adapt prediction results in real time according to the user’s emotional condition.

Therefore, there is a need for a system that can analyze big data using a generative artificial intelligence model to extract variable factors, reuse the extracted variable factors as prompts for further generative processing, and recognize the emotional state of a user so as to adjust prediction results, including detailed workload forecasts, in a manner that is both data-driven and emotionally adaptive.

### SUMMARY

In order to solve the above-described problems, an aspect of the present invention provides a system comprising a processor, wherein the processor is configured to analyze big data and process data using a generative artificial intelligence model that extracts variable factors. By applying the generative artificial intelligence model to large-scale historical and contextual data, the processor automatically identifies latent variable factors that represent influential patterns in the underlying data, such as workload trends, seasonality, external events, or other hidden correlations.

The processor is further configured to input the generated variable factors into the generative artificial intelligence model as a prompt sentence. In one embodiment, the processor converts the variable factors into a structured or natural-language prompt that is supplied to the generative artificial intelligence model so that the model can generate refined predictions, explanations, or scenario-dependent outputs that are conditioned explicitly on the extracted variable factors. This internal prompt mechanism enables the system to link data-driven factor extraction and generative inference in a unified pipeline.

According to another aspect, the processor is configured to recognize an emotional state of a user and adjust a prediction based on the emotional state of the user. For example, the processor may receive user interaction data, such as textual input, voice input, or behavioral indicators, and apply an emotion recognition algorithm to infer the user’s emotional state, such as anxiety, confidence, or uncertainty. The processor then modifies, selects, or rephrases prediction results generated by the generative artificial intelligence model so that the content, level of detail, or presentation is adapted to the recognized emotional state of the user.

In some embodiments, the processor is configured to generate the variable factors using a machine learning algorithm based on the big data. The machine learning algorithm may comprise supervised, unsupervised, or self-supervised learning methods applied to historical workload data, external indicators, and contextual information. The resulting variable factors are used both as internal representations for prediction tasks and as elements of the prompt sentence provided to the generative artificial intelligence model.

In another embodiment, the processor is configured to output a detailed prediction result including at least an increase or decrease in workload and a peak time of the workload, and further adjust the prediction result based on the emotional state of the user. The processor may calculate quantitative indicators, such as forecasted workload levels, changes relative to a baseline, and expected peak times, and then use the recognized emotional state to tailor the granularity, wording, or emphasis of the output. By integrating big data analysis, generative modeling using variable-factor-based prompts, and emotion-aware adjustment of predictions, the system achieves improved usability, trust, and decision support compared to conventional workload prediction systems.

The term “system” refers to an arrangement of one or more hardware devices, software components, or combinations thereof, that cooperate to execute the processing described in the present disclosure.

The term “processor” refers to any hardware component or combination of components capable of executing instructions, including but not limited to a central processing unit (CPU), a graphics processing unit (GPU), a digital signal processor (DSP), an application-specific integrated circuit (ASIC), a field-programmable gate array (FPGA), or a plurality of such components operating in cooperation.

The term “big data” refers to large-scale data sets, which may be structured, semi-structured, or unstructured, that are accumulated from one or more sources over time and that require specialized processing techniques or computing resources to be stored, managed, and analyzed.

The term “analyze” refers to performing one or more computational operations on data, including but not limited to aggregating, filtering, transforming, modeling, or statistically processing the data to extract information, patterns, or relationships.

The term “generative artificial intelligence model” refers to a machine learning model configured to generate new data, outputs, or representations based on learned probability distributions or patterns from training data, including but not limited to generative deep learning models such as transformer-based models, variational autoencoders, or generative adversarial networks.

The term “variable factors” refers to one or more data elements, features, latent representations, or parameters that are extracted or generated from big data by the generative artificial intelligence model or another machine learning algorithm, and that represent influential or explanatory aspects relevant to prediction or analysis.

The term “process data” refers to executing one or more computational operations on input data, including but not limited to feature extraction, transformation, inference, prediction, or generation of new outputs based on the input data.

The term “prompt sentence” refers to a sequence of symbols, which may include text, tokens, or other structured representations, generated from the variable factors and provided as an input condition to the generative artificial intelligence model for controlling or guiding the output of the model.

The term “input generated variable factors into the generative artificial intelligence model as a prompt sentence” refers to transforming the variable factors into a prompt sentence and supplying the prompt sentence to the generative artificial intelligence model as part of the model’s input for subsequent processing or output generation.

The term “user” refers to any human operator or person who interacts with the system, directly or indirectly, for example by providing inputs, receiving outputs, or configuring prediction conditions.

The term “emotional state” refers to a psychological or affective condition of the user, such as anxiety, confidence, stress, satisfaction, or other emotional categories, which can be inferred based on user inputs, behavior, or other observable indicators.

The term “recognize an emotional state of a user” refers to detecting or inferring the emotional state of the user by applying one or more algorithms, such as emotion recognition models, sentiment analysis models, or behavioral analysis models, to data associated with the user.

The term “prediction” refers to an estimated or forecasted value, distribution, or qualitative assessment of a future condition, event, or workload parameter, generated based on big data, variable factors, or model inference.

The term “adjust a prediction” refers to modifying, refining, or selecting a prediction or a representation of the prediction, including its content, format, level of detail, or emphasis, in response to one or more conditions, such as the emotional state of the user.

The term “machine learning algorithm” refers to any algorithm or model that learns parameters or patterns from data, including but not limited to supervised learning, unsupervised learning, semi-supervised learning, or reinforcement learning methods, implemented by techniques such as neural networks, decision trees, regression methods, clustering methods, or ensemble methods.

The term “generate the variable factors using a machine learning algorithm based on the big data” refers to applying the machine learning algorithm to big data so as to compute or derive the variable factors that capture patterns, correlations, or latent structures within the big data.

The term “workload” refers to the quantity or intensity of tasks, operations, transactions, or other work units to be processed by a system, organization, or resource over a specified time period.

The term “detailed prediction result” refers to a prediction output that comprises multiple elements or parameters, such as an increase or decrease in workload, a peak time of the workload, or other derived indicators that describe the predicted workload in a granular manner.

The term “increase or decrease in workload” refers to a predicted change in workload level relative to a reference value, such as a historical average, a baseline period, or a predefined threshold, and may be expressed as an absolute value or a relative value.

The term “peak time of the workload” refers to a point or interval in time within a specified period at which the predicted workload reaches a maximum value or exceeds a specified threshold.

The term “output a detailed prediction result” refers to providing the detailed prediction result from the processor to another component, device, or user, in a form suitable for further processing, display, or use in decision-making.

The term “adjust the prediction result based on the emotional state of the user” refers to changing, rearranging, emphasizing, or rephrasing at least part of the prediction result, or selectively presenting components of the prediction result, in dependence on the recognized emotional state of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

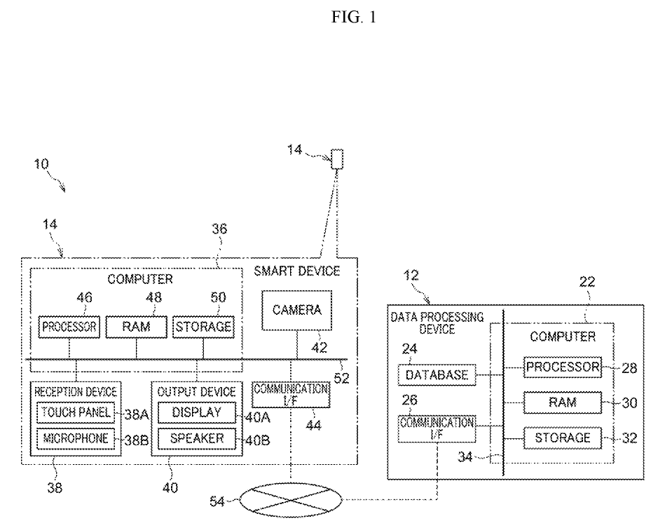

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

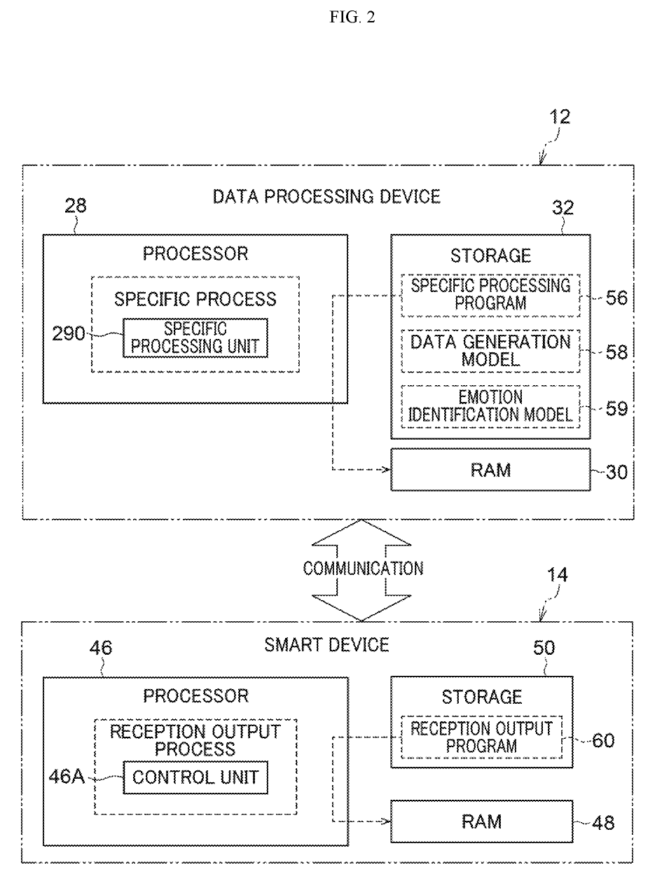

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional business volume forecasting systems typically rely on fixed statistical models or narrowly configured machine learning models that operate directly on historical numerical data. Such systems suffer from several technical limitations in computer-based prediction processing.

First, the processing pipeline in many existing systems is fragmented: numerical prediction is performed in one software component, while natural-language interpretation or scenario analysis, if present at all, is performed separately or manually. This separation prevents the processing device from dynamically combining learned variable factors with flexible natural-language reasoning, and forces the processor to execute multiple disjoint workflows. As a result, the utilization of computing resources for forecast generation is inefficient, and the system cannot adapt its output format or level of detail in response to varying forecast conditions.

Second, although large-scale data sets including external environment-related information and economic condition-related information are increasingly available through data networks, many forecasting systems are not architected to systematically integrate such heterogeneous information in a unified numerical model. The processor therefore fails to learn complex dependencies between internal business-related information and external indicators, leading to degraded prediction accuracy and suboptimal use of available computational capabilities. In particular, conventional systems often lack a mechanism in the processor to transform multi-source time-series data into interpretable variable factors that can be reused across different prediction tasks.

Third, even when advanced models such as deep neural networks are used, their outputs are frequently opaque and difficult to connect with higher-level reasoning. The processor may generate raw numerical predictions, but lacks a structured interface for passing internal variable factors into a generative AI model. Without a standardized prompt sentence constructed from learned factors, the computing device cannot effectively leverage generative AI models to produce detailed, structured, and context-aware forecast explanations. This leads to underutilization of generative models and increases the computational overhead on client devices that must post-process unstructured text.

Fourth, existing systems generally do not incorporate user state information, such as stress level, workload, or preference indicators, into the core prediction pipeline at the processor level. Because of this, the forecast output format and emphasis remain static regardless of user state. From a technical perspective, the processor does not adapt its processing flow or information selection based on user state signals, which can cause information overload, inefficient human–computer interaction, and unnecessary repeated processing on the server and client sides.

Accordingly, there is a need for an improved computer-implemented forecasting system in which a processor (i) collects and preprocesses large-scale multi-source data, (ii) trains and executes a multilayer numerical computation model to generate interpretable variable factors, (iii) automatically constructs prompt sentences incorporating these variable factors as inputs to a generative AI model, and (iv) adjusts prediction results based on user state information. Such a system should improve the internal operation of the processor by optimizing data flows between numerical models and generative models, reduce redundant computations, and enable adaptive, structured output generation that more effectively utilizes available computing resources.

The specific processing by the specific processing unit 290 of the data processing device 12 in Example 1 is realized by the following means.

The present invention provides a server comprising a processor configured to acquire large-scale information including past business-related information, external environment-related information, and economic condition-related information from one or more storage devices or communication interfaces; to preprocess the large-scale information to generate training input information by performing data cleaning, normalization, and feature transformation; to train a multilayer numerical computation model as a deep learning model using the training input information and to execute optimization processing based on gradients using a numerical matrix computation library so as to generate an estimation model configured to output variable factors affecting a business activity amount; to input latest business-related information, external environment-related information, and economic condition-related information into the estimation model and to generate, by computation, variable factors relating to a future business activity amount; to construct, based on the generated variable factors and forecast target conditions, a prompt sentence as an instruction text specifying at least one of a prediction scope and an output format for a generative AI model; to input the prompt sentence to the generative AI model via a programmatic interface and to obtain, from the generative AI model, a prediction result including descriptive information and/or numerical information relating to the future business activity amount in a structured information format; to analyze the structured information to extract, for each time unit, the business activity amount, at least one peak time, and explanatory information for factors associated with the peak time; to format the extracted information as electronic information for business planning in a display format or an output format; and to acquire state information of a user and to adjust at least one of the prediction result and the formatted electronic information based on the state information of the user. This enables the processor of the server to integrate numerical deep learning inference with generative AI model reasoning in a unified data flow, to generate interpretable variable factors and structured forecast outputs with reduced manual post-processing, to adapt the level of detail and emphasis in the forecast according to user state information, and thereby to improve the efficiency, scalability, and responsiveness of computer-based business volume forecasting.

The term “large-scale information” refers to data sets having a volume, variety, and/or velocity that requires automated computer processing for storage, retrieval, and analysis, including time-series data, categorical data, and numerical indicators obtained from multiple sources.

The term “past business-related information” refers to data representing historical business activities of an organization, including but not limited to transaction records, sales quantities, revenues, inventory levels, and customer activity metrics.

The term “external environment-related information” refers to data representing conditions outside an organization that may influence business activities, including market conditions, industry indices, competitor status, and demand or supply indicators.

The term “economic condition-related information” refers to data representing macroeconomic states or trends, including gross domestic product indicators, employment or unemployment indicators, price indices, and monetary or fiscal indicators.

The term “preprocess” refers to performing one or more data transformation operations by a computing device on raw data, including cleaning, normalization, scaling, encoding, feature extraction, and formatting into a structure suitable as input for a numerical model.

The term “training input information” refers to data that has been preprocessed and structured as input samples and associated target values for use in training a numerical model.

The term “multilayer numerical computation model” refers to a computational model implemented as multiple layers of mathematical functions, including neural network layers, that perform numerical operations on input data to generate output values.

The term “deep learning model” refers to a multilayer numerical computation model including a plurality of hidden layers configured to learn complex feature representations from data through parameter optimization based on training examples.

The term “optimization processing based on gradients” refers to a process in which a computing device computes derivatives or gradient values of a loss function with respect to model parameters and updates the model parameters to reduce the loss function.

The term “numerical matrix computation library” refers to software components that provide operations on numerical arrays and matrices, including linear algebra operations, tensor operations, and automatic differentiation, for use in training and executing numerical models.

The term “estimation model” refers to a trained numerical model configured to receive input data and to output one or more estimated values, such as variable factors or predicted quantities, based on learned parameters.

The term “variable factor” refers to a numerical or categorical parameter derived from data that quantifies an influence on a target quantity, such as a factor indicating a trend, seasonality, sensitivity to an external indicator, or other effect on a business activity amount.

The term “business activity amount” refers to a quantitative measure of business operations over a period, including but not limited to sales volume, service requests, production quantity, or transaction count.

The term “forecast target conditions” refers to parameters that specify a scope or constraint of a prediction, including a product category, a geographic region, a time horizon, a time resolution, or a scenario type.

The term “prompt sentence” refers to a text sequence that encodes instructions and context information, including variable factors and forecast target conditions, for input to a generative AI model to request generation of a prediction result.

The term “generative AI model” refers to a trained machine learning model configured to generate output content, including text, numerical values, or structured data, in response to an input prompt sentence.

The term “prediction result” refers to information output by the generative AI model in response to a prompt sentence, including descriptive information, numerical information, or structured information relating to a future business activity amount.

The term “detailed prediction information” refers to prediction result data that has been processed to include breakdowns over time, indications of increases or decreases, identification of temporal peaks, and associated explanatory information.

The term “temporal peak” refers to a time point or time interval at which a predicted business activity amount attains a local or global maximum within a forecast period.

The term “display information” refers to data formatted for presentation on an output device, including graphical elements, charts, tables, or textual summaries.

The term “output information” refers to data formatted for export or further processing by another system, including structured files, messages, or records stored in a data repository.

The term “state information of a user” refers to data representing a condition or preference of a user, including emotional state indicators, workload indicators, attention indicators, or configuration preferences, obtained through sensors, user inputs, or system logs.

The term “structured information format” refers to an arrangement of data in a machine-readable schema, including key–value pairs, arrays, tables, or hierarchical objects, that can be programmatically parsed and processed.

The term “time unit” refers to a discrete temporal interval used for aggregating or expressing prediction results, including a minute, hour, day, week, month, quarter, or year.

The term “electronic information for business planning” refers to digital data prepared for use in planning business operations, including forecasted values, identified peak times, and explanatory factors, in a format suitable for analysis, reporting, or decision support.

In the following embodiments, a data processing apparatus is implemented as a server, and a user-side device is implemented as a terminal. The server executes stored programs to realize the functions described below. The terminal provides a user interface and communicates with the server over a network.

The server includes at least one processor, a main memory, a non-volatile storage device, a network interface, and, in some embodiments, a dedicated accelerator such as a graphics processing unit. The server runs an operating system such as a general-purpose server operating system and executes application programs written, for example, in a high-level programming language. The server uses software libraries for numerical matrix computation, such as a deep learning framework and an array-processing library, stored in the non-volatile storage device and loaded into the main memory when executed.

The server stores, in the non-volatile storage device, a plurality of software modules including a data acquisition module, a preprocessing module, a model training module, a factor generation module, a prompt generation module, a generative-model interface module, a prediction analysis module, and a user-state adjustment module. Each module is realized as a program executed by the processor and cooperates through defined data structures in memory.

The server acquires large-scale information including past business-related information, external environment-related information, and economic condition-related information. The server accesses one or more structured-data repositories, such as a relational database, for past business-related information, and accesses one or more external data-providing systems via network communication protocols for external environment-related information and economic condition-related information. The server stores the acquired information in a storage structure such as time-indexed tables, in which each record contains at least a time identifier, an entity identifier, and a plurality of numerical and categorical fields.

The server preprocesses the large-scale information by executing a sequence of data transformation procedures. The server unifies time zones and time granularities by transforming timestamps to a standard time basis and by aggregating or interpolating values to a common time unit. The server detects missing values in numerical fields and imputes them according to predetermined rules, such as mean imputation or interpolation along the time axis. The server normalizes numerical features by computing, for each feature, a minimum value and a maximum value across a training window and applying a min–max transformation (x − min) / (max − min). The server encodes categorical variables, such as product category and region, into numerical vectors using one-hot encoding or learned embeddings. The server arranges the resulting features into fixed-size vectors and stores them in an array structure, for example an N-by-D matrix in which N represents the number of time steps and D represents the number of features.

The server trains a multilayer numerical computation model as a deep learning model using the preprocessed training input information. In one embodiment, the server defines a neural network that includes an input layer receiving the D-dimensional feature vectors, at least one sequence-processing layer such as a recurrent layer, and at least one fully connected layer for mapping internal representations to output variable factors. In another embodiment, the server uses an attention-based architecture, in which the server computes attention scores between different time steps to capture long-range temporal dependencies.

The server specifies a loss function, such as mean squared error or mean absolute error, between predicted target values and ground-truth values stored in the training input information. The server initializes model parameters, including weight matrices and bias vectors, with small random values. The server performs numerical optimization based on gradients by executing forward propagation and backpropagation over mini-batches of the preprocessed training data. The server computes partial derivatives of the loss function with respect to each parameter using automatic differentiation provided by the numerical matrix computation library. The server updates the parameters according to a selected optimization algorithm, such as stochastic gradient descent or Adam, with a learning rate parameter and optional momentum and regularization parameters.

The server repeats the training cycle for multiple epochs and monitors a validation metric computed on a separate validation subset of the data. The server stores, in the non-volatile storage device, a snapshot of model parameters when the validation metric is improved, which results in an estimation model configured to output variable factors that affect a business activity amount.

The server generates variable factors by executing inference using the trained estimation model. The server acquires latest business-related information, external environment-related information, and economic condition-related information for a forecast period and preprocesses such information using the same normalization parameters and encoding schemes that were applied during training. The server constructs input sequences for the estimation model and executes forward propagation on the processor or on a dedicated accelerator. The server obtains, at output nodes of the model, numerical values representing variable factors, including, for example, trend indices, seasonality coefficients, sensitivity coefficients to external economic indicators, and volatility estimates. The server denormalizes these outputs, when required, to original scales and stores them in a structured data object with explicit labels.

The server constructs a prompt sentence for a generative AI model based on the generated variable factors and forecast target conditions. The server maintains a template data structure in which placeholders represent positions for variable factors, product identifiers, regions, periods, and required output format. The server converts each variable factor to a readable text fragment, for example by formatting a factor with two decimal places and appending a unit, such as percent. The server substitutes the placeholders in the template with these text fragments. In one embodiment, the server constructs a prompt sentence of the following form:

“You are a forecasting assistant. Using the variable factors below, generate a detailed forecast of monthly sales volume for laptop computers in Europe for the next quarter (three months).

Variable factors (normalized and denormalized):

Trend index per month (Month 1, Month 2, Month 3): [1.03, 1.07, 1.10].

- Expected demand growth rate over the quarter: 8.5%.

Seasonality factors (Month 1, Month 2, Month 3): [0.95, 1.10, 1.05].

Anticipated unemployment rate: 6.2%.

Anticipated CPI year-on-year growth: 2.7%.

Historical average monthly sales in the last year: 9,500 units.

Based on these factors, output:
1) The predicted sales volume (in units) for each of the next three months.
2) The month with the highest expected sales (peak month).
3) A concise explanation (within 200 words) of the main reasons for the forecast, referring explicitly to trend, seasonality, and economic conditions.

Output your answer in JSON format with keys ‘month1’, ‘month2’, ‘month3’, ‘peak_month’, and ‘explanation’.”

The server may omit the explicit reference to a structured format if a plain text response is sufficient. In other embodiments, the server varies the level of requested detail and the structure of the output according to forecast target conditions or user preferences.

The server communicates with a generative AI model through a programmatic interface, such as an application programming interface provided over a network. The server sends the constructed prompt sentence as part of a request message that additionally specifies model identity and generation parameters such as maximum length and temperature. The server receives a response message containing a text sequence generated by the generative AI model. The server parses the text response using deterministic parsing rules, which are facilitated by instructing the generative AI model in the prompt sentence to follow specific formatting. The server extracts numerical forecast values for each time unit, identifies peak times by finding maxima in the extracted values, and retrieves explanatory paragraphs.

The server generates detailed prediction information from the parsed prediction result. The server writes the forecast values into a time-series buffer and, if necessary, resamples them to desired time units. The server computes additional derived metrics, such as moving averages, relative changes, and confidence intervals, using predetermined formulas. The server formats the detailed prediction information into a data structure suitable for visualization, including arrays of values and labels for chart axes. The server stores the prediction information in a storage device for subsequent retrieval.

The server acquires state information of a user from logs stored by the terminal and from explicit inputs. The terminal detects user interaction patterns, such as rapid switching of views or repeated requests for the same forecast, and transmits indicators representing user workload or stress. The server also stores user-configured preferences, including preferred verbosity level and detail level. The server maps the state information to control parameters that adjust the prediction result. For instance, if a user is determined to be under high workload, the server compresses explanations to summary sentences and highlights only the most significant peaks. If a user prefers detailed technical explanations, the server requests, in the prompt sentence, more extensive reasoning from the generative AI model and exposes more variable factors in the output.

The server provides forecast results to the terminal as electronic information for business planning. The terminal receives forecast data and formats it for display, for example as charts and tables rendered on a display screen. The user reviews the forecast results via the terminal and may submit new forecast target conditions, state information, or feedback, which the server uses to refine future predictions.

The described configuration improves computer technology in several ways. The server integrates numerical deep learning inference and generative AI inference through explicit variable factors and prompt sentences, thereby reducing redundant computation and data transfer between subsystems. Because the server generates structured variable factors at the estimation model and passes them as explicit inputs to the generative AI model, the server eliminates repeated feature extraction inside separate applications and improves cache locality and memory reuse. This leads to lower processing time for forecast generation compared to systems in which unstructured historical data is provided directly to a generative AI model.

The server improves prediction accuracy by systematically incorporating heterogeneous information sources into a unified deep learning model. The explicit normalization and encoding procedures and the learned parameters of the neural network enable the processor to detect non-linear dependencies and cross-effects between internal business-related information and external economic condition-related information, which cannot be robustly identified by manual rule-based methods. The server’s use of attention mechanisms or recurrent units reduces error accumulation over long forecast horizons by allowing the model to focus on critical past events.

The server enhances data management by maintaining and reusing transformation parameters for normalization and encoding across training and inference. By storing these parameters and enforcing consistent preprocessing, the server ensures that input data distributions at inference match the distributions observed during training, thereby improving stability and reducing prediction variance. Furthermore, the server’s structured storage of variable factors and forecast outputs simplifies indexing and retrieval operations in the database, reducing query latency and I/O overhead.

The server reduces communication load by transmitting compact variable-factor representations and structured prediction results between internal modules, rather than transmitting entire raw data sets or verbose unstructured text. Because the generative AI model is guided by precise variable factors through the prompt sentence, the generative AI model does not need to infer basic context from verbose historical descriptions, which shortens prompts and response lengths and decreases network bandwidth usage and response time.

The server uses learning procedures that are distinct from human mental operations. The server updates model weights based on gradient-based optimization over large mini-batches of data, applying regularization techniques such as weight decay and dropout to prevent overfitting. The server may also perform data augmentation in the time domain, such as adding small perturbations to input features or randomly masking non-critical time steps, which produces a regularized model that generalizes better than models trained without such techniques. These optimization procedures and augmentation methods are specifically designed for computational efficiency and numerical stability and do not correspond to manual forecasting rules.

In alternative embodiments, the server employs different neural network architectures. In one variant, the server uses a convolutional neural network to capture local temporal patterns by applying one-dimensional convolutional filters across time on the feature matrix. In another variant, the server uses a transformer-based encoder composed of multiple layers of self-attention and feed-forward units with residual connections and layer normalization, allowing the server to model long-range dependencies more efficiently. In yet another variant, the server uses a hybrid architecture that combines recurrent units for short-term dependencies and attention units for long-term dependencies. All such architectures maintain the property that the server outputs explicit variable factors for use in prompt sentences.

The server may vary the design of the prompt generation module. In one embodiment, the server maintains multiple prompt templates for different forecast scenarios, such as inventory planning, staffing planning, or capacity planning. The server selects a template based on forecast target conditions and user state information. In another embodiment, the server dynamically constructs sections of the prompt sentence based on the magnitude of variable factors, including only the most influential variables to simplify the instruction to the generative AI model. This selective inclusion reduces prompt size and improves the focus of the generative AI model on relevant information, thereby improving both performance and interpretability.

The server thereby provides a concrete technical implementation that goes beyond abstract data processing. By specifying detailed data structures, training procedures, neural network architectures, and prompt construction mechanisms, and by integrating user state information into the prediction pipeline, the server achieves improved processing speed, prediction accuracy, and resource utilization in computer-based forecasting, which constitutes an improvement to the functioning of the computer system itself.

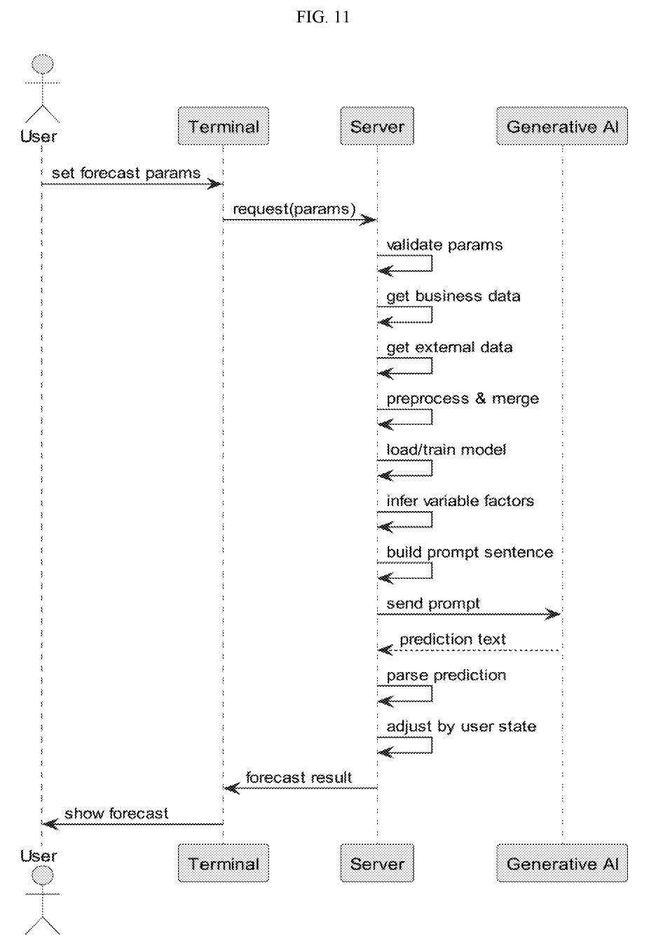

The following describes the processing flow using FIG. 11.

### Step 1

The user operates the terminal to open a forecast screen and specify forecast target conditions. The terminal displays input fields (for example, product category, region, forecast horizon, and time resolution) and receives user input values. The input is a set of forecast parameters, such as “product = laptops, region = Europe, period = next quarter, resolution = monthly.” The terminal converts the input into a structured request object and sends it to the server over a network connection as an HTTP request. The output of this step is a structured forecast request transmitted from the terminal to the server.

### Step 2

The server receives the forecast request and validates the forecast target conditions. The input is the structured request object containing fields such as product identifier, region identifier, start date, end date, and resolution. The server checks data types, required fields, and ranges, and verifies that the identifiers exist in reference tables stored in a database. The server performs comparison and lookup operations on the database tables by executing queries. If validation fails, the server generates an error response. If validation succeeds, the server constructs a normalized internal representation of the request. The output of this step is a validated and normalized set of forecast parameters stored in the server’s memory.

### Step 3

The server acquires past business-related information from internal storage. The input is the validated forecast parameters (for example, selected product and region and a historical time window). The server generates database queries to retrieve historical sales, inventory levels, and related metrics from relational tables. The server executes these queries and receives result sets as rows of records. The server converts these rows into a time-indexed data structure, such as an array of feature vectors keyed by time. The output of this step is a collection of historical business-related records for the specified product, region, and time window.

### Step 4

The server acquires external environment-related information and economic condition-related information from external data sources. The input is the forecast parameters and, optionally, mapping tables that link geographic regions to external indices. The server constructs network requests to external data providers, specifying time ranges and region identifiers. The server receives responses containing time-series values such as market indices, economic growth rates, unemployment indicators, and price indices. The server parses these responses, converts the data to a consistent time format, and stores them as time-indexed sequences aligned by date or period. The output of this step is a set of external environment-related and economic condition-related time-series aligned with the internal business-related data.

### Step 5

The server merges and synchronizes the internal and external data into unified feature sequences. The input is the historical business-related data sequence and the external environment-related and economic condition-related sequences. The server aligns all sequences by time key, performs join operations to combine fields into a single feature vector per time unit, and fills missing entries with default values or marks. The server thereby creates, for each time unit, one composite feature vector containing numerical and encoded categorical values representing business metrics and external indicators. The output of this step is a merged time-series dataset represented as a matrix of size N-by-D, where N is the number of time points and D is the number of features.

### Step 6

The server preprocesses the merged dataset for use as training and inference input. The input is the N-by-D feature matrix with raw values. The server computes summary statistics, such as minimum and maximum values for each numerical feature, and stores these statistics. The server applies normalization and scaling operations by computing, for each feature value x, a normalized value according to (x − min) / (max − min) or another normalization formula. The server encodes categorical variables using one-hot encoding or embeddings, thereby expanding or transforming categorical fields into numerical vectors. The server stores the resulting normalized and encoded vectors in a new matrix for further processing. The output of this step is a preprocessed feature matrix suitable as input to a multilayer numerical computation model, along with stored normalization parameters.

### Step 7

The server prepares training and validation datasets from the preprocessed matrix. The input is the preprocessed feature matrix and associated target labels (for example, past business activity amounts to be predicted). The server splits the time-indexed data into training and validation segments based on time boundaries, assigning earlier periods to training and more recent periods to validation. The server constructs input–target pairs by sliding a window of fixed length over the time axis, where each window of feature vectors becomes an input sequence, and the subsequent time step’s business activity amount becomes the target value. The server stores these pairs as arrays for use by the deep learning framework. The output of this step is a set of training and validation input–target sequences.

### Step 8

The server trains a multilayer numerical computation model as a deep learning model using the training sequences. The input is the training input–target pairs and model configuration parameters, such as number of layers, hidden units, learning rate, and batch size. The server initializes the neural network weights and biases, then iteratively executes forward passes over mini-batches to compute predicted target values. The server computes a loss, for example mean squared error, between predicted and actual targets. The server performs backpropagation using automatic differentiation to compute gradients of the loss with respect to model parameters and updates the parameters using an optimization algorithm. The server repeats this process for multiple epochs and evaluates the validation loss periodically. The output of this step is a trained estimation model whose parameters are stored as a model file.

### Step 9

The server generates variable factors using the trained estimation model. The input is the trained model parameters, the normalization parameters, and the latest preprocessed feature sequences corresponding to the most recent history. The server loads the model parameters and applies the same normalization and encoding functions to the latest raw data as used during training. The server feeds the recent feature sequences into the model in inference mode, executing forward propagation without parameter updates. The model outputs various numerical values at designated output units corresponding to predicted variable factors such as trend indices, seasonality coefficients, and external-sensitivity coefficients. The server may denormalize selected outputs to original scales and label each value with its semantic meaning. The output of this step is a structured set of variable factors represented as labeled numerical values for the forecast period.

### Step 10

The server constructs a prompt sentence for a generative AI model based on the variable factors and forecast target conditions. The input is the set of labeled variable factors and the forecast parameters received from the terminal (for example, product type, region, and forecast period). The server selects an appropriate template that defines the overall structure of the prompt sentence and the requested output. The server formats each variable factor into text (for example, converting 0.085 to “8.5%” and including time-position labels). The server inserts these formatted texts and the forecast parameters into placeholder positions in the template. The server combines the template and the inserted values into a single continuous text string that serves as the prompt sentence. The output of this step is a fully constructed prompt sentence that encodes the variable factors and the desired output format.

### Step 11

The server sends the prompt sentence to a generative AI model and obtains a prediction result. The input is the prompt sentence and, optionally, control parameters for text generation such as maximum length or temperature. The server encapsulates the prompt sentence in a request message and transmits it to the generative AI model via a network or internal inter-process communication interface. The generative AI model returns a text response that describes forecasted business activity amounts and explanatory information. The server receives this response text, which may follow a structured or semi-structured format as instructed in the prompt sentence. The output of this step is a raw prediction result in textual form received from the generative AI model.

### Step 12

The server analyzes the prediction result and extracts structured detailed prediction information. The input is the textual prediction result, which includes forecasted values for each time unit, identification of peak times, and explanatory paragraphs. The server applies parsing logic based on predefined rules and patterns (for example, line breaks, keywords, and delimiters) or based on expected structured sections defined in the prompt sentence. The server converts textual numbers into numerical data types and assigns them to the corresponding time indices. The server identifies peak times by locating maximum values in the time series. The server separates explanatory text segments and links them to the corresponding peaks and trends. The output of this step is a structured prediction object containing numerical forecasted business activity amounts, peak times, and associated explanations.

### Step 13

The server acquires state information of the user and adjusts the prediction information accordingly. The input is the structured prediction object and user state indicators, which the server obtains from the terminal or a user profile database. The server interprets the user state indicators (for example, preference for concise output or high-detail output) and applies rules to transform the prediction object. For example, the server may filter less significant time units, summarize explanations into bullet points, or expand explanations with additional context. The server adjusts the amount of data shown, the level of detail, and the emphasis in the explanations based on these indicators. The output of this step is an adjusted prediction object tailored to the user state.

### Step 14

The server formats the adjusted prediction object as electronic information for business planning and sends it to the terminal. The input is the adjusted prediction object containing numerical time-series data, peak time markers, and explanatory text. The server converts the object into a transport format, such as a JSON document, and includes metadata such as units, time zones, and confidence indicators. The server transmits the formatted data to the terminal in an HTTP response. The output of this step is a response message containing all forecast data required for visualization and further use.

### Step 15

The terminal receives the forecast data and renders it for the user. The input is the response message containing the structured prediction information. The terminal parses the document into internal data structures and generates visual elements, such as graphs showing forecasted business activity amounts over time, markers indicating peak times, and text fields displaying explanations. The terminal may implement interactive components allowing the user to toggle between high-level and detailed views or to change time resolution. The output of this step is a displayed forecast view on the terminal’s screen.

### Step 16

The user reviews the forecast view and may initiate additional forecasts or adjustments. The input is the visualized forecast information and the user’s decision-making needs. The user observes numerical predictions and peak times, reads explanations, and, based on this information, decides whether to request a revised forecast (for example, for another product, region, or period). The user enters new parameters or modifies preferences via the terminal interface. The output of this step is an updated set of user inputs that can be used as new forecast target conditions, which returns the process to Step 1.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional workload forecasting and planning systems in logistics and similar operational environments generally rely on static rule sets, simple statistical models, or manually engineered features that are hard-coded into software. Such systems typically separate low-level data processing from higher-level explanatory output, and do not provide a unified computational framework that transforms heterogeneous historical data into machine-usable features and, in turn, into both numeric forecasts and human-readable guidance. As a result, there are several technical problems.

First, existing systems often process large-scale historical operational data and external environment data using ad hoc scripts or batch tools that are not tightly integrated with the predictive models. The computing resources are not efficiently utilized because feature generation, model execution, and result formatting are decoupled, causing repeated data transfers, redundant computations, and increased latency on general-purpose processors.

Second, many systems treat the generative AI model merely as a black-box predictor, without programmatically generating structured prompt sentences that encode model inputs and intermediate results. This limits the ability of the computing system to automatically produce consistent, context-aware natural language explanations of predictions. As a consequence, users must manually interpret raw time-series outputs and cross-reference multiple dashboards, which degrades the effective throughput of the human–computer interaction and places additional cognitive load on the user.

Third, in conventional architectures, scenario analysis and optimization-based planning are often implemented as standalone modules or external tools. Forecast generation, scenario enumeration, and optimization of staffing and inventory plans are not orchestrated within a single processor-controlled pipeline. This fragmentation leads to repeated serialization and deserialization of data, lack of a unified data representation, and difficulty in performing iterative scenario runs at scale. On a technical level, the system cannot exploit the full capabilities of the underlying processor and memory hierarchy for efficient multi-scenario computation.

Fourth, typical systems do not leverage the outputs of generative learning models to dynamically generate natural language descriptions that explicitly incorporate optimization results such as staffing recommendations and order quantities. Without an integrated mechanism to transform internal prediction tensors and optimization solutions into structured prompt sentences for a generative AI model, the system cannot efficiently deliver machine-generated narratives that are tightly synchronized with the current numerical state of the planning computation.

Accordingly, there is a need for a computer-implemented system that (i) programmatically acquires and preprocesses past operational and external environment data into variable factors suitable for machine learning, (ii) invokes a generative learning model to produce workload prediction information, (iii) uses those predictions as constraints in an optimization model to compute personnel allocation and inventory management plans, and (iv) automatically generates prompt sentences and natural language explanatory or recommendation texts that summarize both the predictive and optimization results. By tightly integrating these functions under control of a processor, the system can improve the efficiency, scalability, and usability of computer-based workload forecasting and planning.

The specific processing by the specific processing unit 290 of the data processing device 12 in Application Example 1 is realized by the following means.

The present invention provides a server comprising a processor configured to acquire past operational information and external environment information from an information storage device; preprocess the acquired information to generate variable factors including time-series indices, aggregated quantities, moving averages, seasonality indices, and external factor indices; transmit the generated variable factors and prediction conditions as structured data to a generative information processing function; input the variable factors as input features into a generative learning model including a deep learning model to generate workload prediction information including future inbound quantities, outbound quantities, and inventory quantities; calculate a personnel allocation plan and an inventory management plan based on the workload prediction information by configuring and solving an optimization model using the workload prediction information as demand constraints; generate display information including the workload prediction information, the personnel allocation plan, and the inventory management plan; generate a prompt sentence including a summary of the workload prediction information and the variable factors; input the prompt sentence into a generative learning model that performs natural language generation processing to generate an explanatory text or a recommendation text; and output the explanatory text or the recommendation text together with the display information to a display device. This enables an integrated computer-implemented pipeline in which the same processor controls feature generation, multi-scenario prediction, optimization-based planning, and natural language explanation, thereby improving computational efficiency, reducing data handling overhead, and enhancing the usability of workload forecasting and planning through automatically generated, context-aware textual guidance.

The term “processor” refers to a hardware computation unit, such as a central processing unit or an accelerator, and associated control circuitry that executes instructions to perform data acquisition, preprocessing, model inference, optimization, and output generation.

The term “information storage device” refers to a hardware storage resource, such as a magnetic disk, a solid-state drive, or a non-volatile memory, that stores past operational information, external environment information, and related datasets.

The term “past operational information” refers to historical data representing operations in a facility or system, including at least records of inbound quantities, outbound quantities, inventory quantities, and timestamps associated with such records.

The term “external environment information” refers to data representing external conditions that may influence operational behavior, including at least market indicators, calendar information, seasonal information, and environmental factors.

The term “preprocess” refers to a series of computation operations executed by the processor on raw data, including at least data cleaning, normalization, aggregation, and transformation into structured formats suitable for machine learning.

The term “variable factors” refers to feature values derived from past operational information and external environment information, including at least time-series indices, aggregated quantities, moving averages, seasonality indices, and external factor indices used as inputs to a learning model.

The term “time-series indices” refers to numerical or categorical values indicating temporal positions or patterns, including at least day-of-week, week-of-year, month, and holiday flags.

The term “aggregated quantities” refers to numerical values obtained by summing or averaging raw operational records over a defined time interval, unit, or category.

The term “moving averages” refers to smoothed numerical values obtained by averaging quantities over a sliding time window along a time axis.

The term “seasonality indices” refers to variables that represent recurring temporal patterns in the data, including at least periodic effects associated with days, weeks, months, or seasons.

The term “external factor indices” refers to variables representing the influence of external conditions, including at least indicators of promotions, economic activity, or environmental factors.

The term “structured data” refers to data represented in a predefined format with explicit fields and relationships, including at least tabular data, key-value pairs, or serialized objects suitable for transmission between software components.

The term “generative information processing function” refers to a software-controlled processing unit or module that receives structured data including variable factors and prediction conditions, and that applies a generative learning model to produce prediction outputs.

The term “generative learning model” refers to a computational model trained using data-driven learning techniques to generate outputs, including at least a model that can produce predicted values or natural language texts based on input features or prompt sentences.

The term “deep learning model” refers to a learning model composed of multiple layers of parameterized transformations, including at least neural network layers, and trained using optimization algorithms to minimize a loss function.

The term “workload prediction information” refers to predicted values representing future operational loads, including at least future inbound quantities, outbound quantities, and inventory quantities for designated time intervals.

The term “inbound quantities” refers to numerical values representing incoming items or units into a facility or system during a defined time interval.

The term “outbound quantities” refers to numerical values representing outgoing items or units from a facility or system during a defined time interval.

The term “inventory quantities” refers to numerical values representing stored items or units present in a facility or system at a defined point in time or time interval.

The term “personnel allocation plan” refers to data that specifies numbers of personnel and their assigned working periods or tasks for one or more time intervals.

The term “inventory management plan” refers to data that specifies control operations for inventory, including at least target inventory levels, replenishment quantities, and ordering times.

The term “optimization model” refers to a mathematical formulation comprising decision variables, constraints, and an objective function, used by the processor to compute a solution that satisfies constraints and optimizes the objective.

The term “demand constraints” refers to constraint conditions within the optimization model that use workload prediction information to limit or specify required capacity, including at least constraints related to predicted inbound, outbound, or inventory quantities.

The term “display information” refers to information formatted for output to a display device, including at least graphical elements, textual elements, and tabular elements representing predictions and plans.

The term “display device” refers to an apparatus capable of presenting visual information, including at least a monitor, a terminal screen, or a mobile display.

The term “prompt sentence” refers to a structured natural language or semi-structured text that encodes a summary of workload prediction information, variable factors, or conditions, and is used as input to a generative learning model for natural language generation.

The term “explanatory text” refers to a natural language output generated by a generative learning model that describes or interprets workload prediction information or planning results.

The term “recommendation text” refers to a natural language output generated by a generative learning model that proposes actions or strategies based on workload prediction information and planning results.

The term “natural language generation processing” refers to a computational procedure performed by a learning model to produce grammatically and semantically coherent text in a human language based on input data or prompt sentences.

The term “scenario conditions” refers to parameters that define different hypothetical or planned situations for prediction and planning, including at least variations in demand levels, operational constraints, or external environment conditions.

The term “planning proposal” refers to a concrete set of values for decision variables obtained by solving the optimization model, including at least numbers of personnel, work assignments, and order quantities for inventory.

The term “key points” refers to elements of the planning proposal that the system identifies as important for understanding or decision-making, including at least major changes in staffing, significant inventory adjustments, or critical time periods.

The term “risk information” refers to indications of potential adverse outcomes or uncertainties associated with the planning proposal, including at least risk of stockouts, overload of personnel, or sensitivity to prediction errors.

In one embodiment, a server, a terminal, and a user cooperate to implement the claimed system. The server includes at least one processor, a main memory, a non-volatile storage device such as a solid-state drive, and a network interface. The terminal includes a display device, an input device, and a network communication module. The user operates the terminal. The server executes an operating system such as a general-purpose server operating system and middleware including a web server framework and an application framework. The server further executes application programs written in a programming language such as a scripting language or a general-purpose compiled language.

The server stores past operational information and external environment information in an information storage device. The past operational information includes records of inbound quantities, outbound quantities, and inventory quantities for one or more facilities, associated with timestamps and identifiers for items and locations. The external environment information includes calendar information, seasonal information, and external indices such as market indicators or event flags. The server stores these datasets in a relational database system or a distributed data store. The server defines explicit data schemas, for example tables with columns for timestamp, location identifier, item identifier, inbound quantity, outbound quantity, inventory quantity, market index, season flag, and event flag. The server uses these schemas to enforce structural consistency and to enable indexed access to time-series data.

The server preprocesses the past operational information and the external environment information to generate variable factors. The server loads raw records from the information storage device into main memory as in-memory tabular structures, for example two-dimensional arrays or data frame objects. The server performs data cleansing operations, including removal of duplicate records, conversion of string-formatted timestamps into numerical timestamps, and imputation of missing values using deterministic rules such as forward fill or median replacement. The server normalizes numerical fields by subtracting a mean value and dividing by a standard deviation computed over a training period. The server stores normalization parameters in configuration data so that the same transformation is applied consistently during inference.

The server generates time-series indices by computing, for each record, derived fields such as day-of-week, week-of-year, month-of-year, and binary holiday flags. The server generates aggregated quantities by grouping records by time interval, item, and location, and computing sums or averages of inbound quantities, outbound quantities, and inventory quantities. The server generates moving averages by applying a sliding window operator over the time axis, computing, for example, a seven-day moving average and a thirty-day moving average for each quantity. The server generates seasonality indices by encoding periodic patterns such as weekly or yearly cycles using encoding methods such as cyclic encoding into sine and cosine values. The server generates external factor indices by transforming raw external environment signals, such as discrete event flags or continuous market indices, into scaled or binned numerical representations.

The server organizes the variable factors into feature tensors suitable for input to a generative AI model. The server arranges features in a fixed order along a feature axis and arranges time steps along a time axis. The server uses padding and masking techniques to align variable-length time-series sequences. The server encodes categorical identifiers, such as item category or location identifier, into integer indices, and then uses embedding layers in the model to map those indices to continuous vectors. By enforcing a fixed tensor layout, the server reduces cache misses and improves memory locality when the processor and any attached accelerator perform tensor operations.

The server implements the generative AI model as a generative learning model including a deep learning model. In one embodiment, the server uses a sequence model consisting of an encoder-decoder architecture. The server configures the encoder as a stack of recurrent neural network layers, such as gated recurrent units or long short-term memory layers, or as a stack of self-attention-based transformer layers. The server configures the decoder as a set of autoregressive layers that output future workload values step by step, conditioned on encoded historical sequences. The server defines model parameters such as the number of layers, the dimensionality of hidden states, the number of attention heads, and non-linear activation functions. The server stores these parameters and trained weight matrices in the information storage device.

The server trains the generative learning model by executing a training process on a training dataset constructed from historical data. The server divides the data into training, validation, and test sets by time period or by facility. The server defines a loss function for numeric prediction, for example a mean squared error or a quantile regression loss over predicted inbound, outbound, and inventory quantities. The server computes gradients of the loss function with respect to model parameters using backpropagation through time or backpropagation through the computation graph. The server updates the model parameters using an optimization algorithm such as stochastic gradient descent or an adaptive gradient method. The server performs mini-batch training, where each mini-batch contains multiple time-series segments. The server optionally uses regularization techniques such as dropout or weight decay to prevent overfitting.

The server improves training efficiency by allocating model computations to a hardware accelerator such as a graphics processing unit. The server transfers feature tensors from main memory to device memory, performs matrix multiplications and non-linear operations on the accelerator, and then transfers gradients back to main memory for parameter updates. This hardware-specific scheduling reduces training time compared to a purely serial implementation on the processor.

After training, the server uses the generative learning model for inference. The server receives, from the terminal, prediction conditions such as facility identifier, forecast horizon, and scenario type. The terminal sends these conditions as structured messages over a network using a network protocol. The server, in response, constructs input feature tensors by selecting and preprocessing appropriate historical windows for the specified facility and time range. The server passes the tensors through the trained encoder and decoder, generating workload prediction information including future inbound quantities, outbound quantities, and inventory quantities at each time step. The server may generate both point forecasts and distribution parameters for probabilistic forecasts. The server writes the predicted sequences to in-memory buffers and to persistent storage if necessary.

The server computes personnel allocation plans and inventory management plans by formulating and solving an optimization model. The server defines decision variables such as the number of workers in each time slot and the order quantity for each item in each period. The server defines constraints based on workload prediction information, including minimum required handling capacity, maximum allowable inventory levels, and operational constraints such as shift length and worker availability. The server constructs an objective function, for example minimizing a weighted sum of labor cost, inventory holding cost, and penalty terms for delay or stockout. The server uses a mathematical programming solver implemented in software to solve the optimization problem. The server supplies coefficient matrices and vectors representing constraints and the objective function to the solver and receives a solution vector representing an optimized plan.

The server binds the optimization model and the generative learning model in a pipeline. The server uses predicted workload sequences directly as time-dependent demand parameters in the optimization model. Because the server uses a unified data representation for predictions and constraints, the server avoids repeated parsing and re-encoding of data. This pipeline results in reduced processing latency and lower memory bandwidth usage compared to architectures that rely on manual export and import between separate tools. The causal link between the prediction module and the optimization module is explicit: changes in predicted workload immediately change constraint values, and the solver produces different plans accordingly.

The server generates display information for the terminal. The server formats the workload prediction information, the personnel allocation plan, and the inventory management plan into structured datasets suitable for visualization. The server may generate time-series arrays for plotting, tabular summaries for key performance indicators, and summarized statistics such as average daily inbound volume or peak inventory level. The server sends the display information to the terminal via a network response.

The terminal receives the display information and renders graphical elements on the display device. In one embodiment, the terminal executes a web browser that runs client-side scripts to render line charts for inbound, outbound, and inventory forecasts, bar charts for required personnel per shift, and tables for recommended order quantities. The terminal displays user interface controls that allow the user to change filters such as facility, time range, and scenario conditions. The terminal sends updated requests to the server when the user changes these controls. The user views the predictions and plans on the display device and can adjust or confirm planning decisions.

The server generates a prompt sentence for a natural language generative learning model. The server constructs the prompt sentence by embedding structured summaries of workload prediction information and variable factors into natural language templates. For example, the server converts key statistics into text segments such as “The predicted inbound volume next month peaks on the 10th and 20th days, with expected values approximately 30 percent above the monthly average.” The server concatenates such segments with instructions for the generative learning model. The server then forms a prompt sentence. In one example, the server uses the following prompt sentence:

“Using the following forecast data of inbound, outbound, and inventory levels for the next month at a warehouse, summarize the main demand peaks, potential stockout risks, and recommended staffing adjustments for each week. Provide a concise explanation in English.”

In another example, the server uses the following prompt sentence:

“Based on past one year of logistics data and market trends, and given the predicted inbound and outbound volumes for next month, generate a detailed narrative describing how the logistics center should allocate staff across shifts and adjust inventory levels to minimize cost while maintaining service quality.”

The server supplies these prompt sentences, together with embedded structured data or derived text summaries, to a generative AI model configured for natural language generation. The server arranges the input as token sequences and passes them through a transformer-based language model residing on the server or on an attached accelerator. The server configures the language model architecture with multiple self-attention layers, feed-forward layers, and positional encodings. The server decodes text using a predetermined strategy such as beam search or nucleus sampling. The server restricts output length and vocabulary to enforce domain-appropriate language.

The server generates explanatory texts or recommendation texts from the output token sequences produced by the language model. The server post-processes these outputs by filtering out incomplete sentences, checking for required terms such as “peak”, “risk”, and “recommendation”, and aligning references to dates and quantities with the underlying prediction data. By deriving prompt sentences automatically from internal model outputs and by post-processing the generated texts with deterministic rules, the server ensures that explanations remain consistent with the numerical state of the system. This differs from manual report drafting because the server exploits internal tensor representations and structured summaries to generate context-aware prompts that are not easily constructed by humans at scale.

The terminal receives the explanatory texts or recommendation texts from the server together with the display information. The terminal renders the texts as narrative sections below or beside the charts and tables. The user reads the explanatory texts or recommendation texts and can quickly understand key points of the predictions and plans without manually analyzing all numeric details. When the user changes prediction conditions or scenario parameters, the terminal transmits the updated conditions to the server, which recomputes features, regenerates workload prediction information, re-solves the optimization model, and regenerates prompt sentences and explanatory texts.

The system improves computer technology in several ways. The server uses a specific data structure for variable factors and a specific tensor layout for time-series features, which reduces memory fragmentation and enhances vectorized computation on the processor and accelerator. By unifying feature generation, prediction, and optimization into a single coordinated pipeline running on the same server, the system reduces data serialization overhead and network traffic between computational modules. The server schedules model inference and optimization solving in a manner that reuses cached data and pre-allocated tensors, reducing processing latency and improving throughput.

The server also improves prediction accuracy by employing learning algorithms that use multiple types of derived variable factors, such as moving averages, seasonality encodings, and external factor indices, and by training the deep learning model with an appropriate loss function and regularization. The use of scenario conditions and repeated model runs allows the server to compute multiple prediction scenarios quickly while caching intermediate representations. This is a non-conventional arrangement relative to simple batch statistical reporting systems.

The generative AI model used for natural language generation is not merely a substitute for a human writer. The server uses internal knowledge of feature tensors, prediction results, and optimization outputs to construct prompt sentences with structured patterns that direct the language model to focus on relevant aspects of system state. The server applies nonstandard, machine-oriented rules to decide which statistics to include in the prompt and how to order them. By doing so, the system uses the language model as a component in a broader computational pipeline, thereby increasing the effective information density of the user interface while minimizing network bandwidth and processing overhead on the terminal.

In alternative embodiments, the server may employ different neural network architectures, such as convolutional neural networks for local temporal patterns or hybrid models combining recurrent and attention mechanisms. The server may employ different optimization algorithms, such as interior-point methods or heuristic algorithms, depending on problem size and constraint structure. The data store may be implemented using a distributed file system or a columnar database instead of a relational database. The terminal may be a mobile device, a desktop workstation, or an industrial terminal. The user may interact with the system using voice commands, in which case the terminal performs speech recognition and transmits recognized text to the server.

In all such embodiments, the core mechanism remains that the server transforms raw operational and external data into structured variable factors, applies a generative learning model to generate workload prediction information, uses those predictions as inputs to an optimization model to compute operational plans, and automatically generates prompt sentences and natural language texts that explain and recommend actions based on the computational results. The coupling of these modules under control of a single processor and within defined data structures yields a concrete technical implementation that goes beyond abstract data manipulation and improves the operation of computer systems used for workload forecasting and planning.

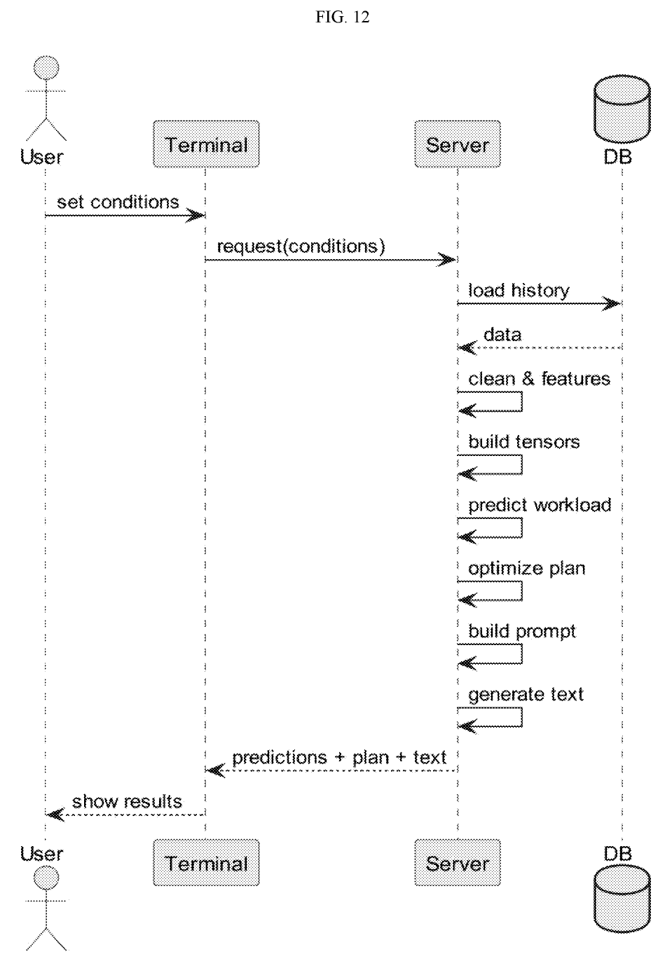

The following describes the processing flow using FIG. 12.

### Step 1

The server acquires configuration parameters and user-specified prediction conditions.

The terminal sends, as input, a request that includes at least a facility identifier, a prediction horizon, a time range for historical data, and one or more scenario conditions. The server parses the request, validates parameter types and ranges, and stores them in an in-memory configuration structure. The output of this step is a validated condition set that is used to control subsequent data acquisition and processing.

### Step 2

The server acquires past operational information and external environment information from an information storage device.

The input to this step is the validated condition set from Step 1. The server uses the facility identifier and historical time range to construct one or more database queries. The server sends the queries to a relational database or a structured data store and receives records of inbound quantities, outbound quantities, inventory quantities, timestamps, location identifiers, and external indices such as market indicators and event flags. The server loads these records into in-memory tabular structures, such as data frames. The output of this step is a pair of in-memory datasets: past operational information and external environment information, both filtered according to the conditions.

### Step 3

The server cleans and normalizes the acquired datasets.

The input to this step is the raw past operational information and external environment information from Step 2. The server removes duplicate rows by comparing primary keys (for example, timestamp, location, and item identifiers), and discards or merges inconsistent records. The server converts timestamp strings into numeric time values, converts categorical codes into canonical identifiers, and checks for missing values. For each numerical field, the server calculates statistics such as mean and standard deviation and applies normalization by subtracting the mean and dividing by the standard deviation. The server stores the normalization parameters for later use. The output of this step is a cleaned and normalized dataset that is free of duplicates, type inconsistencies, and unhandled missing values.

### Step 4

The server generates time-series indices and aggregated quantities.

The input to this step is the cleaned and normalized dataset from Step 3. The server derives time-series indices such as day-of-week, week-of-year, and month-of-year by computing integer values from the timestamps. The server adds holiday flags by consulting a calendar table or rules. The server groups records by facility, item, and fixed time intervals (for example, daily) and calculates aggregated quantities such as daily inbound totals, daily outbound totals, and end-of-day inventory levels. The output of this step is an enriched dataset containing original fields plus time-series indices and aggregated quantities for each time interval and entity.

### Step 5

The server computes moving averages, seasonality indices, and external factor indices.

The input to this step is the enriched dataset from Step 4. The server applies sliding window operations along the time axis to compute moving averages, for example seven-day and thirty-day moving averages for inbound, outbound, and inventory quantities. The server generates seasonality indices by encoding periodic patterns, for example by mapping day-of-week and month-of-year into sine and cosine pairs. The server transforms external environment signals into external factor indices by scaling, binning, or smoothing raw external variables such as market indicators. The server combines these derived values into additional columns. The output of this step is a set of variable factors that include time-series indices, aggregated quantities, moving averages, seasonality indices, and external factor indices.

### Step 6

The server converts variable factors into feature tensors for a generative AI model.

The input to this step is the set of variable factors from Step 5 and the facility and item identifiers. The server arranges the variables into fixed-order feature vectors for each time step, and then stacks the vectors over time to form sequences. The server pads or truncates sequences to a fixed length according to model configuration and generates corresponding masks to indicate valid time steps. The server encodes categorical identifiers into integer indices and records them in separate arrays. The output of this step is a collection of feature tensors and masks, organized for efficient input to a deep learning-based generative learning model.

### Step 7

The server executes the generative AI model to generate workload prediction information.

The input to this step is the feature tensors and masks from Step 6 and the prediction horizon from Step 1. The server loads the parameters of the trained generative learning model from storage into main memory and, if available, into accelerator memory. The server performs forward propagation by computing matrix multiplications, non-linear activations, attention operations, and recurrent or transformer layer outputs. For each prediction time step in the forecast horizon, the server generates predicted inbound quantities, outbound quantities, and inventory quantities. The server may also compute distribution parameters for probabilistic forecasts. The output of this step is workload prediction information represented as tensors or arrays indexed by time, facility, and item.

### Step 8

The server formats workload prediction information into structured records.

The input to this step is the workload prediction information from Step 7. The server maps tensor indices back to explicit timestamps, facility identifiers, and item identifiers. The server denormalizes predicted values using the stored normalization parameters to obtain predicted quantities in original units. The server constructs structured records, such as rows with timestamp, facility, item, inbound prediction, outbound prediction, and inventory prediction. The server may compute summary statistics, such as peak daily inbound value or average weekly outbound value. The output of this step is a structured prediction dataset that is ready for both storage and downstream planning computation.

### Step 9

The server constructs and solves an optimization model for personnel allocation and inventory management.

The input to this step is the structured prediction dataset from Step 8 and optimization-related conditions such as maximum staff, shift structure, and inventory capacity limits from Step 1. The server defines decision variables representing the number of personnel in each time slot and order quantities for each item and time interval. The server defines constraints using the predicted inbound, outbound, and inventory quantities as demand constraints, ensuring that available personnel capacity and inventory flows satisfy or exceed required processing volumes. The server formulates an objective function, for example minimizing a weighted combination of labor cost, holding cost, and penalty cost. The server passes these matrices and vectors to an optimization solver and runs the solver until convergence or a stopping criterion is met. The output of this step is an optimized plan containing values for personnel numbers, work assignments, and order quantities.

### Step 10

The server generates display information containing predictions and plans.

The input to this step is the structured prediction dataset from Step 8 and the optimized plan from Step 9. The server constructs visualization-oriented data structures, such as time-series arrays grouped by variable type and plan tables grouped by facility and time slot. The server computes derived indicators like safety stock levels, utilization rates, and slack capacity. The server bundles these elements into a response object that includes numerical arrays, formatted labels, and metadata such as model version and generation time. The output of this step is display information ready to be transmitted to the terminal.

### Step 11

The server generates a prompt sentence for a natural language generative AI model.

The input to this step is the structured prediction dataset from Step 8, the optimized plan from Step 9, and the display metrics from Step 10. The server selects salient statistics, such as the top three peak days, the largest staffing changes, and the highest risk of stockout. The server inserts these statistics into a predefined text template to form a prompt sentence. For example, the server may create the following prompt sentence:

“Using the following forecast data of inbound, outbound, and inventory levels for the next month at a warehouse, summarize the main demand peaks, potential stockout risks, and recommended staffing adjustments for each week. Provide a concise explanation in English.”

Alternatively, the server may create the following prompt sentence:

“Based on past one year of logistics data and market trends, and given the predicted inbound and outbound volumes for next month, generate a detailed narrative describing how the logistics center should allocate staff across shifts and adjust inventory levels to minimize cost while maintaining service quality.”

The server encodes the prompt sentence into tokens and prepares it as input for the language model. The output of this step is a tokenized prompt sentence and associated context ready for natural language generation.

### Step 12

The server generates explanatory text or recommendation text using a generative AI model.

The input to this step is the tokenized prompt sentence from Step 11 and, optionally, additional structured tags or summaries. The server runs a transformer-based language model by computing self-attention, context mixing, and feed-forward operations across the token sequence. The server decodes output tokens using a configured decoding strategy to form coherent sentences. The server then post-processes the generated text, checking for alignment with the underlying predictions and plans and correcting inconsistent references when necessary. The output of this step is an explanatory text or recommendation text that describes forecast peaks, potential risks, and suggested staffing and inventory actions.

### Step 13

The server transmits display information and generated texts to the terminal.

The input to this step is the display information from Step 10 and the explanatory or recommendation text from Step 12. The server packages these elements into a network response formatted, for example, as structured data along with textual sections. The server sends the response over a network connection to the terminal. The output of this step is a transmitted response that encapsulates all visual and textual content required by the terminal.

### Step 14

The terminal renders visual and textual information for the user.

The input to this step is the network response from Step 13. The terminal parses the structured data into internal objects and draws charts, tables, and indicators on the display device. The terminal places the explanatory or recommendation text in a readable area near the graphical components. The terminal provides user interface controls that allow the user to change filters, adjust scenario parameters, or request new forecast horizons. The output of this step is an updated visualization and narrative on the display, enabling the user to observe the predictions and proposed plans.

### Step 15

The user reviews the presented information and optionally issues new requests.

The input to this step is the visual display and narrative presented by the terminal. The user examines predicted inbound, outbound, and inventory trajectories, the personnel allocation plan, the inventory management plan, and the generated explanation or recommendation. The user may modify scenario conditions, such as tightening capacity constraints or changing target service levels, using the input controls on the terminal. The terminal sends the updated conditions back to the server, which re-enters the processing flow from Step 1 or Step 2. The output of this step is refined user input that triggers new cycles of prediction, optimization, and explanation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional workload prediction systems typically rely on statically designed data-processing pipelines and pre-defined machine learning models. In such systems, engineers manually design data preprocessing logic, feature engineering procedures, model architectures, and visualization workflows, and then implement and deploy corresponding software components. This static design makes it difficult to timely adapt the prediction behavior to changes in data characteristics, operational conditions, or user requirements. As a result, these systems often exhibit degraded prediction accuracy, inefficient use of computational resources, and high maintenance cost when confronted with evolving business environments and complex, large-scale datasets.

Further, existing systems generally separate the generative artificial intelligence components from the core prediction pipeline. Generative models, when used, are typically limited to assisting with report generation or natural language interaction, and are not tightly integrated into the generation of executable data-processing programs or into dynamic reconfiguration of prediction logic. Consequently, the potential of generative artificial intelligence to automatically synthesize, update, and optimize the underlying computational procedures based on historical data and user feedback is not fully realized.

In addition, conventional workload prediction frameworks inadequately exploit fine-grained historical information and contextual conditions, such as time-based patterns, derived statistical indicators, and external condition information. Many implementations use only coarse-grained aggregates or a limited set of manually selected features, which restricts the modeling capacity and reduces the robustness of predictions, especially when large-scale information with heterogeneous attributes must be handled.

Moreover, existing visualization and user-interaction mechanisms are often one-way: the system outputs graphs or charts, but user operations and user emotional state are not effectively incorporated as feedback signals to adjust or refine the underlying models or prediction results. Without a closed feedback loop grounded in user interaction data and user affective state, it is difficult to provide prediction outputs that are both technically accurate and aligned with user expectations, trust levels, and decision-making needs.

There is therefore a need for an improved computer-implemented system that: (i) uses a generative artificial intelligence model to automatically generate and update data-processing programs for preprocessing, feature generation, and workload prediction based on large-scale historical information; (ii) tightly couples prompt sentences and generative artificial intelligence outputs into the computational pipeline itself; (iii) constructs rich variable factors including time information, statistical information, and external condition information to enhance prediction quality; and (iv) incorporates user operation information and user emotional state information as dynamic feedback to adjust the prediction results and their visualization. Such a system would improve the functioning of computers themselves by enabling adaptive program synthesis, more efficient processing of large-scale information, and interactive, user-aware prediction behavior that is computationally integrated rather than additively layered on top of static models.

The specific processing by the specific processing unit 290 of the data processing device 12 in Example 2 is realized by the following means.

The present invention provides a server comprising a processor configured to store large-scale information in an information storage unit; acquire historical information stored in the information storage unit; construct a prompt sentence for generating an information processing program; input the prompt sentence into a generative AI model; acquire, from the generative AI model, the information processing program that executes variable factor generation processing and future workload prediction processing based on the historical information; execute the information processing program to perform, by a statistical processing unit, preprocessing on the historical information including missing-value completion processing and outlier processing; generate variable factors from the historical information including time information, statistical information, and external condition information; store the variable factors as a group of features in a data structure; input, into the generative AI model, the variable factors and a further prompt sentence including prediction conditions; calculate, by using the generative AI model or a machine learning program generated by the generative AI model, a prediction result including a time transition of future workload, an increase/decrease trend of the workload, and peak time periods; input the prediction result into a visualization processing program; execute the visualization processing program to generate, based on the prediction result, image information including at least one of a graph along a time axis, a category-based bar graph, and a time-period-based density representation; cause an output device to display the image information; acquire operation information of a user and emotional state information of the user with respect to the displayed prediction result; construct a prompt sentence including an adjustment condition based on the operation information and the emotional state information; re-input the prompt sentence into the generative AI model; and update contents of the prediction result based on an updated output of the generative AI model. This enables an improvement of computer functionality by allowing the server to automatically synthesize and adapt executable data-processing and prediction programs in response to large-scale historical information and user feedback, thereby enhancing prediction accuracy, computational efficiency, and interactive usability in workload forecasting.

The term “processor” refers to one or more hardware-based processing units, such as a central processing unit or a graphics processing unit, that execute instructions of programs to perform data processing operations described in this specification.

The term “information storage unit” refers to one or more data storage resources, such as a memory device or a non-volatile storage device, configured to store large-scale information including historical information and prediction results.

The term “large-scale information” refers to data having a volume, variety, or velocity that requires automated computational processing, and includes, for example, time-series records, event logs, and contextual condition data collected over an extended period.

The term “historical information” refers to past data records relating to workload or other operational quantities and associated contextual attributes, such as timestamps, statistical values, and external conditions, which are used as input for prediction processing.

The term “prompt sentence” refers to a sequence of characters expressed in a natural language or structured text, provided as an input to a generative AI model to specify a processing task, a program generation request, prediction conditions, or adjustment conditions.

The term “generative AI model” refers to a parameterized computational model, such as a neural network-based language model, that generates outputs including natural language text, program code, or parameter values in response to an input prompt sentence.

The term “information processing program” refers to executable or interpretable instructions, such as program code, that when executed by the processor cause the processor to perform operations including preprocessing, variable factor generation, and workload prediction.

The term “statistical processing unit” refers to a functional component implemented by execution of program code on the processor, configured to perform statistical operations such as missing-value completion, outlier processing, and normalization on historical information.

The term “missing-value completion processing” refers to a procedure of detecting absent or undefined data entries within historical information and replacing them with substitute values determined according to a predefined rule or statistical method.

The term “outlier processing” refers to a procedure of detecting data points in historical information that deviate from expected ranges or distributions and handling such data points by removal, capping, transformation, or other corrective actions.

The term “variable factor” refers to a data element derived from or associated with historical information, including time information, statistical information, and external condition information, which is used as a feature for machine learning or prediction.

The term “time information” refers to one or more data attributes derived from temporal data, including, for example, a timestamp, a day of week, a time of day, a calendar date, or a time interval identifier.

The term “statistical information” refers to one or more quantities computed from historical information, such as an average, a variance, a standard deviation, a moving average, or another statistical measure over a defined time window.

The term “external condition information” refers to data describing circumstances external to the workload itself, such as environmental conditions, event indicators, or operational flags, that may influence the workload and are associated with corresponding time points.

The term “group of features” refers to a collection of variable factors organized as a feature set suitable for input to a generative AI model or a machine learning program for training or inference.

The term “data structure” refers to an organized representation of data in memory or storage, such as a table, an array, or an object collection, that stores variable factors and supports access, update, and computational operations.

The term “prediction conditions” refers to parameters or constraints specified for a prediction task, including at least one of a prediction time range, a prediction resolution, a target quantity, or assumed external conditions.

The term “prediction result” refers to output data representing a computed estimate of future values of workload or related quantities, including, for example, time-series values, trend indicators, and peak time periods.

The term “time transition of future workload” refers to a sequence of predicted workload values associated with successive time points, indicating how the workload is expected to change over time.

The term “increase/decrease trend of the workload” refers to an indication of directional change in predicted workload over a time interval, such as whether the workload is increasing, decreasing, or remaining stable.

The term “peak time periods” refers to time intervals within a prediction horizon during which predicted workload values exceed one or more thresholds or are locally maximal relative to neighboring time intervals.

The term “machine learning program” refers to program code that, when executed by the processor, causes construction, training, and inference of a machine learning model based on input features and target data, and that may be generated by the generative AI model.

The term “visualization processing program” refers to program code that, when executed by the processor, generates image information or graphical representations based on prediction results or other data.

The term “graph along a time axis” refers to a visual representation, such as a line chart or area chart, that plots one or more quantities as functions of time along a horizontal or vertical axis.

The term “category-based bar graph” refers to a visual representation composed of bars corresponding to categories, such as days, shifts, or resource groups, where a height or length of each bar indicates a numerical value derived from prediction results.

The term “time-period-based density representation” refers to a visual representation, such as a heat map or intensity map, that displays levels of workload or related values across time periods using color or shading variations.

The term “output device” refers to any hardware device configured to present information to a user, such as a display device, a terminal, or another visual output interface.

The term “operation information of a user” refers to data representing interaction actions taken by a user with respect to displayed information, including, for example, selection operations, zoom operations, filter settings, or input modifications.

The term “emotional state information of the user” refers to data representing or estimating a user’s affective condition, such as levels of satisfaction, confidence, stress, or concern, obtained through explicit user input, sensor measurements, or inference algorithms.

The term “adjustment condition” refers to one or more constraints or modification directives derived from operation information and emotional state information, which specify how prediction results or associated visualizations should be adapted or recalculated.

The term “learning model” refers to a parameterized model constructed through a learning process on training data, which, when provided with input features, outputs predictions or inferences related to the workload.

The term “numerical sequence of future workload” refers to an ordered list or array of numerical prediction values corresponding to future time points for which the workload is estimated.

The term “visualization information” refers to data defining one or more graphical or image-based representations of prediction results, suitable for rendering on an output device.

The term “resource allocation” refers to a distribution plan or recommendation for assigning computational resources, human resources, or other operational resources across time periods or tasks based on prediction results.

In one embodiment, a server implements the system by executing one or more programs on a hardware platform including at least one processor, a main memory, a non-volatile storage device, and a network interface. The server uses an information storage unit, such as a relational database system or a distributed file system, to store large-scale historical information representing workload records and associated contextual attributes. The server communicates with at least one terminal operated by a user through a communication network. The terminal includes a display device, an input device, and a browser or dedicated client application that allows the user to view prediction results and to provide operation information and emotional state information.

The server uses a generative AI model to generate an information processing program. The server, by executing a prompt-construction module, forms a prompt sentence in natural language that specifies details of required data acquisition, preprocessing, feature generation, model training, inference, and visualization. The server inputs the prompt sentence into the generative AI model via a programmatic interface. The generative AI model, in one example, is a large language model implemented as a multi-layer neural network including an embedding layer, multiple self-attention layers, and feed-forward layers. The server receives, from the generative AI model, the information processing program as text representing executable instructions.

The server may host the generative AI model locally on a computing node equipped with graphics processing units or may access a remote generative AI model provided by a cloud-based AI service through an application programming interface. The generative AI model is trained in advance on large corpora of code and natural language and is further conditioned by the server using prompt sentences that describe the schema and statistical properties of the historical information. The generative AI model internally uses sequence modeling algorithms, such as transformer-based attention, to predict subsequent tokens of program code, conditioned on the prompt sentence that encodes the required operations.

The server stores the generated information processing program in the non-volatile storage device and executes the information processing program in a controlled execution environment, such as a container or a virtual environment. The server loads historical information from the information storage unit using database client software. The historical information may include, for example, timestamps, measured workload values, flags indicating events, and identifiers of external conditions such as environment codes. The historical information is read into a data structure in memory, such as a tabular structure analogous to a data frame.

The server, under control of the information processing program, performs preprocessing by a statistical processing unit implemented as executable routines. The server detects missing values in the historical information and completes those missing values using predefined statistical rules, such as forward filling, interpolation, or replacement with central tendency values. The server detects outliers by computing statistical measures such as means and standard deviations and compares each workload value to predetermined thresholds. The server modifies or removes data entries that exceed such thresholds according to an outlier-handling rule. By performing missing-value completion processing and outlier processing in this manner, the server produces a cleaned dataset that avoids numerical instability and model degradation in subsequent prediction steps.

The server generates variable factors from the historical information. The server computes time information by decomposing each timestamp into multiple attributes such as year, month, day, hour, minute, day-of-week, and holiday flags. The server computes statistical information by applying sliding-window operations over the time axis to derive moving averages, moving variances, and lagged values of workload. The server maps external condition information, such as environment indicators and event identifiers, into numerical representations using encoding procedures. The server aggregates these derived attributes into a group of features, each represented as an element of a structured data vector. The server stores the group of features in a data structure configured to be used as input to a machine learning model, for example a two-dimensional array where each row corresponds to a time point and each column corresponds to a variable factor.

The server constructs prompt sentences that describe the generated variable factors and required prediction conditions, and reuses the generative AI model as a computational component in the prediction pipeline. For example, the server may construct a prompt sentence such as:

“Using the provided features including day_of_week, hour, is_weekend, lagged workload values, and rolling statistics, create a model that predicts the workload for each thirty-minute interval of next month and outputs peak time periods.”

In another example, the server may construct a prompt sentence such as:

“Generate an executable program that reads historical workload data, cleans missing and outlier values, creates time-based and statistical features, trains a neural network, and outputs forecasts and peak intervals.”

The server inputs such prompt sentences, together with schema descriptions and summary statistics, into the generative AI model and obtains a machine learning program or a direct configuration of a machine learning model. In one embodiment, the machine learning program implements a neural network that includes an input layer receiving the group of features, one or more hidden layers, and an output layer producing predicted workload values. The hidden layers may be composed of recurrent units, such as long short-term memory units, or may be composed of one-dimensional convolutional layers, or fully connected layers with non-linear activation functions. The neural network is trained by the server using gradient-based optimization, where the server iteratively computes a loss function, such as mean squared error between predicted and actual workload values, and updates weights of the neural network according to a learning rate and an optimization rule, such as stochastic gradient descent or adaptive moment estimation.

The server, by executing the machine learning program produced by the generative AI model, constructs a learning model based on the historical information and the group of features. The server partitions the dataset into training, validation, and test subsets using deterministic or random segmentation rules. The server performs data augmentation in time-series space if necessary, for example by adding noise within predefined bounds or by generating overlapping time windows, to increase the robustness of the learning model. During training, the server monitors validation loss and may apply early stopping or learning rate scheduling to prevent overfitting and to accelerate convergence. This training process enhances the internal parameters of the learning model such that the learning model captures non-linear temporal dependencies and contextual influences that are not easily modeled by manual rule-based methods.

The server applies the trained learning model to generate prediction results for a specified future period. The server constructs future feature rows by extrapolating time information and by inserting assumed external condition information based on scenario parameters. The server inputs these feature rows into the learning model and obtains a numerical sequence of future workload values. The server further computes derived metrics such as increase/decrease trends and peak time periods by applying algorithmic rules, for example computing differences between successive time points or detecting local maxima exceeding configured thresholds. As a result, the server generates a prediction result that includes a time transition of future workload, trend indicators, and a list of peak time periods.

The server translates the prediction result into visualization information. The server invokes a visualization processing program that generates graphical representations, such as line charts along the time axis, bar graphs summarizing workloads per category, and time-period-based density maps that assign colors according to workload magnitude in a matrix of days versus hours. The server renders such visualization information into image data stored in memory buffers and transfers the image data to an output device associated with the terminal. The terminal displays the visualization information to the user through its display device, enabling the user to inspect predicted workload patterns and peaks.

The terminal acquires operation information from the user through input mechanisms such as selection of particular time spans, adjustment of prediction horizons, or toggling of assumed external conditions. The terminal may also acquire explicit emotional state information from the user, such as textual indications of confidence or concern, or may obtain signals from sensors and submit such signals to the server for emotional state estimation. The server receives the operation information and emotional state information, and combines them to form adjustment conditions. The server constructs a further prompt sentence that encodes these adjustment conditions and provides it to the generative AI model. The server may use examples of such prompt sentences as:

“Given that the user is not confident about the predictions for weekend evenings, adjust the model or parameters to more heavily weight recent weekend data and recompute the forecast.”

“Considering that the user is highly concerned about underestimation during promotional events, modify the prediction strategy to increase sensitivity to external event indicators and regenerate the peak detection.”

By re-inputting such prompt sentences to the generative AI model, the server obtains updated programs or model configurations that adapt not only to data statistics but also to user feedback and user emotional state. The server executes the updated programs to recompute prediction results and updates the visualization information accordingly. This closed-loop mechanism allows the server to operate under non-conventional automated rules: the generative AI model synthesizes specialized data-processing and modeling procedures that dynamically reflect both the data environment and user feedback, rather than applying static parameter adjustments that could be scripted manually.

The server improves computer technology in several technical aspects. First, the server reduces human intervention in the design of data-processing pipelines by using the generative AI model to generate and update executable programs. This reduces the number of manual configuration steps and allows the system to adapt to new data distributions without extensive code rewriting. Second, the server improves prediction accuracy and stability compared to conventional static models by systematically constructing rich variable factors and by training neural networks that capture complex interactions between time information, statistical information, and external condition information. Third, the server increases computational efficiency by allowing the generative AI model to synthesize programs that are optimized for the structure of the data, including specific batching schemes, window sizes, or feature transforms that reduce memory usage and reduce unnecessary computation. Fourth, the server reduces communication load between the terminal and the server because the terminal transmits compact operation information and emotional state information instead of full datasets, and the server performs all heavy computations locally based on stored historical information.

The server employs non-conventional processing sequences that differ from typical human-designed workflows. For example, the server uses iterative prompt-based optimization of the information processing program itself: the server observes model errors, user reactions, and emotional state signals, encodes these observations in new prompt sentences, and triggers the generative AI model to produce variant programs with modified preprocessing, feature selection, or model architectures. The server then evaluates these variants according to computational metrics and prediction performance and retains improved configurations. This autonomous evolution of the computational pipeline constitutes a computer-centric optimization mechanism that does not have a direct manual counterpart.

The server can implement multiple embodiments of the learning model. In one embodiment, the server uses a recurrent neural network with long short-term memory units to model sequential dependencies over time. In another embodiment, the server uses a temporal convolutional network that applies one-dimensional convolutions across the time dimension to capture local patterns over multiple scales. In yet another embodiment, the server uses an attention-based model that directly relates workload values at different time points through attention weights, enabling the model to attend to distant but relevant historical events. In each embodiment, the server defines a loss function, such as mean squared error or mean absolute percentage error, and updates model parameters by backpropagation and gradient-based optimization. The server may also apply regularization techniques such as dropout, weight decay, or early stopping to prevent overfitting and to stabilize learning.

The server may also vary the structure of the group of features. In one mode, the server includes only time information and direct workload history, providing a compact input representation that favors speed over richness. In another mode, the server incorporates additional statistical information, such as rolling quantiles or exponentially weighted moving averages, to increase sensitivity to recent trends. In a further mode, the server extends the feature set with categorical encodings of external conditions, such as event categories or environment types, enabling the learning model to differentiate between structurally different operating regimes. These alternative embodiments allow adaptation to constraints such as available computational resources, communication bandwidth, and desired prediction granularity.

The server further improves data management through systematic storage of intermediate data structures. The server maintains, in the information storage unit, a feature store that maps time stamps to feature vectors, versioned by feature schema and processing parameters. This structured storage allows efficient reuse of features across different prediction tasks and reduces repeated computation, thereby improving throughput and reducing processing time. The server also logs prediction results and corresponding user feedback along with metadata describing model versions and configuration identifiers, enabling traceability and reproducibility of predictions.

The terminal operates primarily as an interface for visualization and feedback. The terminal receives pre-rendered image data or compact visualization descriptions from the server and displays them using its display device. The terminal captures fine-grained user interactions, such as pointer movements over specific graph regions or successive zoom operations, and transmits these interactions as operation information to the server. The terminal may additionally provide interfaces for the user to input natural language comments expressing subjective evaluations of the predictions. Such comments can be incorporated into prompt sentences that the server sends to the generative AI model.

The user interacts with the terminal by examining the displayed prediction results, performing operations such as selecting problematic intervals, and optionally providing emotional state feedback. The user does not need to understand details of the underlying machine learning models or data-processing programs. The system thereby enables domain experts, rather than only technical engineers, to guide the adaptation of the prediction pipeline. Nevertheless, the actual adaptation takes place inside the server, which modifies concrete program code, data structures, and learning model configurations based on the computational logic of the generative AI model, yielding improvements in prediction performance and computational efficiency that exceed mere automation of human-performed tasks.

In summary, the server, the terminal, and the user cooperate in a system in which the server uses a generative AI model and prompt sentences not only to generate predictions but also to generate and refine the underlying programs and data structures that implement prediction processing. This architecture provides a technical solution that improves the operation of computers for handling large-scale information by increasing adaptability, computational efficiency, accuracy, and user-aligned behavior in the context of workload forecasting and similar prediction tasks.

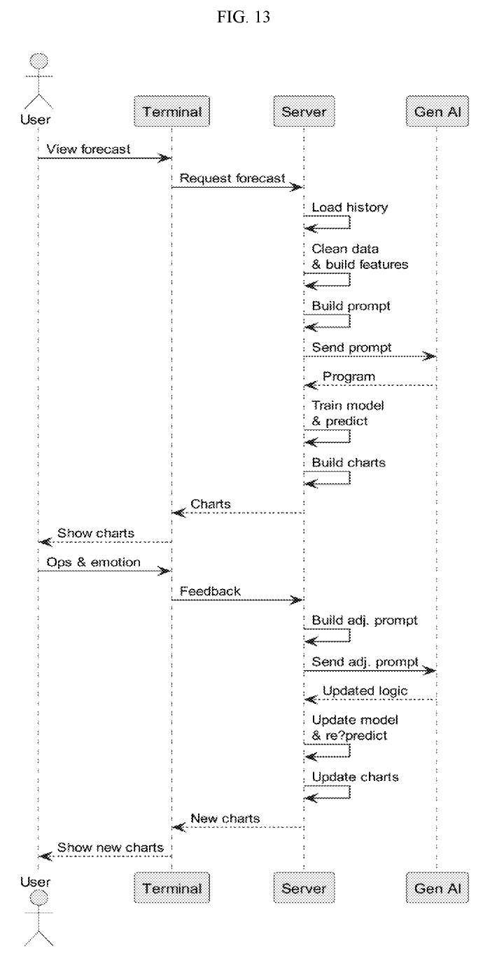

The following describes the processing flow using FIG. 13.

### Step 1

The server acquires historical information from an information storage unit.

The server uses a database client or file-system interface to read records including timestamps, workload values, and external condition attributes. As input, the server receives a query condition (for example, a time range and target tables). Based on this input, the server executes retrieval operations, such as structured queries, to obtain matching records. The server converts the retrieved records into an in-memory tabular data structure, such as a table where each row represents a time point and each column represents a raw attribute. As output, the server produces a raw dataset containing historical information to be used in subsequent processing.

### Step 2

The server preprocesses the historical information to produce a cleaned dataset.

The server takes the raw dataset from Step 1 as input. The server scans each column to detect missing entries and computes replacement values, such as forward-filled values, mean values, or interpolated values, depending on a predefined rule. The server also computes statistical measures, such as mean and standard deviation for workload columns, and identifies entries that exceed threshold values to classify them as outliers. The server then either removes the corresponding rows or replaces the abnormal values with capped values determined by percentile statistics. Through these data transformations, the server generates a cleaned dataset that has no missing entries and reduced influence of outliers. As output, the server produces a normalized and cleaned dataset suitable for feature generation.

### Step 3

The server generates variable factors (features) from the cleaned dataset.

The server uses the cleaned dataset of Step 2 as input. The server decomposes each timestamp into multiple time information attributes such as day-of-week, hour, holiday flag, and time-slot index. The server calculates statistical information such as moving averages, moving standard deviations, and lagged values by sliding windows over the time axis. The server encodes external condition information, such as environment codes and event flags, into numerical or categorical indicators. The server then aggregates these derived values into a feature vector for each time point and stores them in a structured data matrix. This matrix forms the group of features used as input to learning models. As output, the server produces a feature dataset and an associated target sequence of workload values.

### Step 4

The server constructs a prompt sentence describing program requirements and model behavior.

The server uses metadata about the feature dataset from Step 3, including column names, data types, and summary statistics, as input. The server arranges this metadata together with requirements such as prediction horizon, desired model type, and output format into a natural language description. The server composes a prompt sentence specifying that a program should load the features, train a model, and output predictions and peak time periods. An example prompt sentence is: “Generate an executable program that reads historical workload data, cleans missing and outlier values, creates time-based and statistical features, trains a neural network, and outputs forecasts and peak intervals.” As output, the server produces a structured prompt sentence ready to be sent to a generative AI model.

### Step 5

The server sends the prompt sentence to a generative AI model and receives an information processing program.

The server uses the prompt sentence generated in Step 4 as input. The server transmits this prompt sentence via a network interface to a generative AI model endpoint. The server waits for a response containing generated program text that describes data loading, preprocessing, feature usage, model training, and prediction logic. The generative AI model processes the prompt and returns program code as a sequence of characters. The server receives this program text and stores it in non-volatile storage as a file or an entry in a code repository. As output, the server obtains an information processing program that can be executed to perform prediction-related operations.

### Step 6

The server executes the generated information processing program in a controlled environment.

The server uses the stored program from Step 5 and the feature dataset from Step 3 as input. The server initializes an execution environment, such as a container or virtual environment, and invokes the program with references to the feature dataset and target data. During execution, the program accesses the feature dataset, splits it into training and validation sets, and initializes a learning model architecture. The program then iteratively trains the learning model by computing prediction outputs, comparing them to ground truth workload values, and updating internal weights according to an error function and an optimization rule. As output, the server obtains a trained learning model and optionally intermediate artifacts such as model parameter files.

### Step 7

The server generates prediction results for future time periods using the trained learning model.

The server uses the trained learning model and future feature inputs as input. The server constructs future feature rows by extrapolating time information (for example, next month’s date and time combinations) and by inserting assumed external condition information. The server feeds these feature rows into the learning model. The learning model performs numerical computations over the network layers, reading feature vectors, applying weight matrices and activation functions, and outputting predicted workload values for each future time point. The server collects these outputs into a structured prediction dataset. The server further analyzes this dataset to compute derived values such as increase/decrease trends and to identify peak time periods by comparing predicted values to thresholds or local neighbors. As output, the server generates a prediction result set that includes predicted workload sequences and identified peak intervals.

### Step 8

The server converts the prediction results into visualization information.

The server uses the prediction result set from Step 7 as input. The server applies visualization routines that map numerical values into graphical elements. For example, the server constructs a time-series line by mapping time indices to positions along a horizontal axis and predicted workload values to positions along a vertical axis. The server constructs bar graphs by grouping predictions by day or category and assigning bar heights according to aggregated values. The server constructs time-period-based density representations by arranging predicted values into a grid of days versus hours and assigning colors according to value magnitude. The server encodes these graphical elements into image data or structured drawing commands. As output, the server produces visualization information ready to be transmitted to a terminal.

### Step 9

The terminal receives the visualization information and displays prediction results to the user.

The terminal uses the visualization information and image data from Step 8as input. The terminal receives this data via a communication interface and decodes it into visual elements. The terminal draws graphs, charts, and density maps on the display device, mapping pixel values to corresponding colors, lines, and labels. The terminal may also display auxiliary textual information such as numeric peak values or total predicted workload. As output, the terminal produces a visual presentation of the prediction results that the user can perceive and analyze.

### STEP 10

The user interacts with the prediction results and provides operation information and emotional state information.

The user uses the terminal display from Step 9 as input to understand predicted workload patterns. The user performs operations such as selecting specific time intervals on the graphs, zooming in on regions of interest, or choosing alternative prediction horizons from menu controls. The user may also input textual comments or select icons indicating emotional states such as “confident,” “uncertain,” or “concerned.” These interactions generate operation information and emotional state information within the terminal. As output, the user causes the terminal to produce data describing chosen time ranges, settings, and emotional indicators.

### Step 11

The terminal sends operation information and emotional state information to the server.

The terminal uses the interaction data produced in Step 10 as input. The terminal packages operation information, such as selected time intervals and modified parameters, together with emotional state information into a structured message. The terminal transmits this message to the server via the network interface. As output, the terminal delivers feedback data that can be used by the server to adjust prediction behavior.

### Step 12

The server constructs an adjustment prompt sentence based on user feedback and updates prediction logic.

The server uses the operation information and emotional state information from Step 11, together with prior prediction results from Step 7, as input. The server analyzes these inputs to determine adjustment conditions, such as increasing emphasis on specific time spans or external conditions. The server then constructs a new prompt sentence that encodes these adjustment conditions. For example, the server may generate a prompt sentence such as: “Given that the user is not confident about the predictions for weekend evenings, adjust the model to more heavily weight recent weekend data and recompute the forecast.” The server sends this adjustment prompt sentence to the generative AI model and receives updated program fragments or configuration parameters. The server integrates these updates into the information processing program or learning model and re-executes relevant training or inference steps. As output, the server produces revised prediction results that reflect both data characteristics and user feedback.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional workload and delivery volume prediction systems in information processing environments typically rely on fixed statistical models or generic machine learning models that operate on pre-aggregated data. These systems suffer from several technical shortcomings.

First, conventional systems generally do not implement an integrated, machine-executable pipeline that automatically performs fine-grained preprocessing of heterogeneous large-scale time-series information (including operational, environmental, and economic data), feature extraction, variable factor identification, and prediction within a single processor-controlled workflow. As a result, the systems often process inconsistent or partially cleaned data, leading to degraded prediction accuracy and unstable behavior across different time horizons and domains.

Second, traditional systems rarely generate structured variable factors and then transform those factors, together with prediction context, into a machine-generated prompt sentence for a generative AI model in a systematic, template-based manner. Instead, any use of generative AI is typically ad hoc and manually crafted. This lack of structured prompt generation prevents the generative AI model from effectively leveraging underlying time-series patterns and context, and it complicates reproducibility, traceability, and automated tuning of the prompt design.

Third, conventional architectures do not integrate recognized user emotion states as machine-usable inputs that directly affect the preprocessing pipeline, variable factor weighting, and subsequent prediction and planning logic. Emotion, if considered at all, is treated as a separate, non-technical overlay rather than a formal feature used in model training and inference. This leads to systems that cannot dynamically adjust workload predictions or resource allocation plans based on real-time human factors, thereby limiting robustness in environments such as logistics operations, call centers, and production facilities.

Fourth, existing systems typically output raw prediction values without converting them into optimized resource allocation or scheduling plans formulated as computational optimization problems. As a consequence, downstream resource planning is often performed manually or with simplistic heuristics that do not fully utilize prediction outputs, leading to inefficient use of workers, transportation assets, and facilities.

Fifth, many systems lack a closed feedback loop in which realized performance data and user-applied plan corrections are systematically collected as machine-readable signals and used to update both the underlying machine learning models and the generative AI prompt templates. Without such a loop, prediction models and prompt structures remain static, gradually diverging from real-world conditions and causing long-term degradation in prediction quality and in the suitability of the generated plans.

Therefore, there is a need for a computer-implemented system that technically improves the way large-scale time-series data is preprocessed, how variable factors and emotion states are integrated, how generative AI models are invoked via structured prompt sentences, how prediction outputs are transformed into optimized resource allocation plans, and how feedback is used to adapt models and prompts over time. Such a system should reduce computational inconsistency, improve prediction accuracy, provide more efficient automated scheduling, and enhance the robustness and adaptability of computer-based workload and delivery planning.

The specific processing by the specific processing unit 290 of the data processing device 12 in Application Example 2 is realized by the following means.

The present invention provides a server comprising a processor configured to acquire large-scale time-series information including operational information, environment information, and economic information for workload prediction or delivery volume prediction; to preprocess the large-scale time-series information by performing machine-executable operations including missing-value completion, outlier removal, normalization, and time-series alignment to generate a preprocessed information set; to calculate feature values from the preprocessed information set, the feature values including moving averages, change rates, seasonality indicators, and environment indicators; to perform correlation analysis or dimensionality reduction analysis on the feature values to identify variable factors that influence the workload or the delivery volume and to store the identified variable factors as a group of variable factors; to obtain an emotion state of a user by analyzing emotion-related data from an image input device or a sound input device with an emotion recognition algorithm, to generate emotion state information as an emotion label or an emotion score including at least one of joy, anger, and fatigue, and to record the emotion state information in association with the group of variable factors; to construct a machine learning model by learning a relationship between past workload or delivery volume and future workload or delivery volume based on the group of variable factors and the emotion state information, and to generate prediction information by numerically estimating future workload or future delivery volume at a future time using the machine learning model; to generate a prompt sentence for input to a generative AI model by formatting explanation input information, including the group of variable factors, the emotion state information, and the prediction information, into a natural-language form and describing past information sequences, the emotion state, and a prediction target; to hold a template for the prompt sentence, including placeholders for inserting the group of variable factors and the emotion state information as human-readable numerical sequences and descriptive text, and to dynamically construct the prompt sentence, which simultaneously includes a prediction request and a factor-explanation request, by replacing the placeholders with concrete values corresponding to the group of variable factors, the emotion state information, and a prediction target period; to input the prompt sentence to an internal or external generative AI model, to analyze a natural-language output obtained from the generative AI model, to extract prediction result information including prediction values relating to the future workload or the future delivery volume and explanatory information regarding factors of the prediction values, and to convert the prediction result information into structured data; to formulate a resource allocation plan or a schedule plan, including worker numbers, work time zones, transportation means numbers, and facility operation states, as an optimization problem based on the prediction information and the prediction result information, to calculate the resource allocation plan or the schedule plan based on constraint conditions and evaluation indices, and to perform adjustment including load reduction or insertion of rest periods according to the emotion state information; to convert the prediction information, the prediction result information, and the resource allocation plan or the schedule plan into visualization information arranged by time axis, area, and work unit, to transmit the visualization information to a terminal device for display, to receive scenario specification, emotion state correction, or plan correction input from the user via the terminal device, and to reflect the input in the prediction information and the resource allocation plan or the schedule plan; and to calculate error indices between at least one of the prediction information and the prediction result information and actual workload or delivery volume acquired as performance data, to record plan correction information provided by the user via the terminal device as additional learning data, and to periodically update the machine learning model and a template for generation of the prompt sentence using the error indices and the plan correction information so as to improve future prediction accuracy and a degree of fit of the resource allocation plan. This enables a technical improvement in computer-based workload and delivery planning by providing a unified, processor-controlled pipeline that integrates advanced data preprocessing, emotion-aware feature modeling, structured prompt-based interaction with a generative AI model, optimization-based resource scheduling, and feedback-driven model and prompt adaptation, thereby enhancing computational robustness, prediction accuracy, and efficiency of automated resource allocation.

The term “large-scale time-series information” refers to digital data sets comprising chronologically ordered records collected over time from multiple sources, including but not limited to operational logs, environmental measurements, and economic indicators, which are sufficiently voluminous and heterogeneous to require automated preprocessing and analysis by a computing device.

The term “operational information” refers to data representing activities, states, or performance of a business process or system, such as workload counts, delivery volumes, call volumes, machine utilization, or worker shift records, which are stored in an electronic storage device and processed by a computing device.

The term “environment information” refers to data representing external physical or contextual conditions, such as temperature, precipitation, weather classifications, or calendar-based seasonality, that are acquired from sensors or information services and are capable of influencing workload or delivery volume.

The term “economic information” refers to data representing macroeconomic or microeconomic conditions, such as economic indices, market indicators, or sales statistics, that are obtained from information services and are usable as explanatory variables for predicting workload or delivery volume.

The term “preprocessed information set” refers to a collection of records derived from large-scale time-series information after machine-executed operations including missing-value completion, outlier removal, normalization, and time-series alignment have been performed to make the records suitable for feature calculation and model input.

The term “feature values” refers to numerical or categorical values computed from the preprocessed information set, such as moving averages, change rates, seasonality indicators, and environment indicators, which represent characteristics of the underlying data and are used as inputs to a machine learning model.

The term “moving average” refers to a feature value calculated as an average of data samples over a specified time window that shifts along a time axis, and that is used to smooth short-term fluctuations and highlight longer-term trends.

The term “change rate” refers to a feature value representing a relative or absolute difference in a data value between two or more time points, such as a percentage increase or decrease, which is used to express temporal variation.

The term “seasonality indicator” refers to a feature value representing periodic patterns, such as day-of-week, month-of-year, or holiday flags, that recur over time and can influence workload or delivery volume.

The term “environment indicator” refers to a feature value derived from environment information, such as a discretized temperature level, a precipitation flag, or a classification of weather condition, which is used as an input to a prediction model.

The term “variable factors” refers to selected feature values or groups of feature values that have been determined, based on correlation analysis or dimensionality reduction analysis, to have a substantial influence on workload or delivery volume and that are used as explanatory variables in prediction processing.

The term “group of variable factors” refers to a structured set of variable factors associated with corresponding time indices or scenarios, which is stored in a storage device and used as input for model training, prediction, and prompt generation.

The term “emotion-related data” refers to digital signals, such as images, video frames, or audio waveforms, captured from a user by an input device and containing information from which an emotion state of the user can be inferred by an emotion recognition algorithm.

The term “emotion recognition algorithm” refers to a software-implemented procedure that analyzes emotion-related data using pattern recognition, statistical modeling, or machine learning techniques to classify or score the emotion state of a user.

The term “emotion label” refers to a symbolic representation of an inferred emotion state, such as joy, anger, fatigue, or neutral, which is output by an emotion recognition algorithm and stored as discrete data.

The term “emotion score” refers to a numerical value or vector of values indicating degrees or probabilities of one or more emotion states of a user, as computed by an emotion recognition algorithm.

The term “emotion state information” refers to data representing an emotion state of a user, including at least one of an emotion label and an emotion score, which is associated with corresponding time indices or scenarios and used as an input to prediction and planning processing.

The term “machine learning model” refers to a computational model, implemented in software and executed by a processor, that is parameterized and trained on historical data to learn a mapping between input variables, including variable factors and emotion state information, and output variables, including future workload or delivery volume.

The term “prediction information” refers to numerical data representing estimated future workload or delivery volume at one or more future time points, generated by executing a machine learning model or other prediction logic on input features.

The term “generative AI model” refers to a machine learning model designed to produce natural-language text or other structured outputs in response to an input prompt sentence, by using learned statistical relationships between tokens or features, and executable either on a local computing device or on an external computing service.

The term “prompt sentence” refers to a sequence of natural-language tokens or structured text, generated by a processor according to a template and containing numerical data, descriptive context, and explicit instructions, which is input to a generative AI model to request prediction and explanation.

The term “explanation input information” refers to data prepared for input to a generative AI model that includes at least a group of variable factors, emotion state information, and prediction information, formatted in a natural-language compatible structure to support both numerical prediction and explanatory output.

The term “prediction result information” refers to information extracted from an output of a generative AI model, including predicted values regarding future workload or delivery volume and natural-language explanations regarding factors or reasons for the predicted values, which is converted into structured data.

The term “structured data” refers to data organized in a machine-readable format, such as a table, record set, or labeled array, in which fields for prediction values, explanatory text, and associated indices are explicitly defined.

The term “resource allocation plan” refers to a calculated arrangement of resources, including worker numbers, work time zones, transportation means numbers, and facility operation states, obtained by solving an optimization problem that uses prediction information and prediction result information as inputs.

The term “schedule plan” refers to a temporal assignment of tasks, workers, transportation means, or facilities over a planning horizon, computed as a result of optimization processing and stored in a format suitable for execution and display.

The term “optimization problem” refers to a mathematical formulation comprising decision variables, constraint conditions, and an objective function, which is solved by an algorithm executed by a processor to determine a resource allocation plan or a schedule plan that optimizes one or more evaluation indices.

The term “evaluation indices” refers to quantitative criteria, such as cost, workload balance, service level, or utilization rate, that are used in an objective function of an optimization problem to evaluate and compare different resource allocation or scheduling solutions.

The term “visualization information” refers to data structures prepared for display on a terminal device, including values and labels arranged by time axis, area, and work unit, suitable for rendering charts, tables, or other graphical representations.

The term “terminal device” refers to an electronic device, such as a client computer, mobile communication device, or display apparatus, that receives visualization information from the server, presents the information to a user, and transmits user input back to the server.

The term “scenario specification” refers to user-provided input indicating conditions or parameters for a prediction or planning scenario, including at least one of a target period, a target region, or an operational mode, which the server uses to select or generate prediction and planning results.

The term “plan correction input” refers to user-provided modifications to a resource allocation plan or a schedule plan, such as changes in worker assignments or transportation resources, which are transmitted from the terminal device to the server as machine-readable data.

The term “error indices” refers to quantitative measures, such as mean absolute error or percentage error, that represent differences between predicted workload or delivery volume and actual workload or delivery volume observed as performance data.

The term “plan correction information” refers to data representing differences between an original resource allocation plan or schedule plan generated by the system and a revised plan approved or edited by a user, which is stored as additional learning data for subsequent model or template updates.

The term “template for generation of the prompt sentence” refers to a stored pattern of natural-language text containing placeholders, which are programmatically replaced with concrete values of variable factors, emotion state information, prediction targets, or time periods to form a specific prompt sentence for a generative AI model.

In one embodiment, a server, a terminal, and a user cooperate to implement the invention. The server comprises at least one processor, a main memory, a non-volatile storage device, and a network interface. The terminal comprises at least one processor, a display device, input devices, and optionally a camera and a microphone. The user interacts with the terminal to review prediction results, supply scenario parameters, and optionally correct emotion states and plans.

The server executes an operating system such as a general-purpose server operating system and executes application software written, for example, in a high-level programming language. The server uses a relational database management system to store historical operational information, environment information, economic information, prediction results, model parameters, and templates for prompt sentences. The server further uses software libraries for numerical computation and machine learning, such as a data frame processing library (for example, Pandas), a machine learning library (for example, a library for gradient-boosting trees or a neural network framework), and a deep learning framework (for example, a framework supporting recurrent neural networks and Transformer architectures). The server also uses an HTTP client library to communicate with an external generative AI model provided as a network service.

The server stores large-scale time-series information as structured records. The server, for example, stores operational information such as daily arrival counts in a logistics facility, hourly call volumes in a call center, or hourly machine utilization rates in a manufacturing line, in a table whose primary key includes at least a timestamp and a facility identifier. The server stores environment information, such as temperature, precipitation, and weather category, in a separate table indexed by timestamp and geographic region. The server stores economic information such as consumer confidence indices and sales indices in a table indexed by date and region. The server defines foreign-key relationships between these tables so that the processor can join them efficiently on common keys, such as date and region.

The server reads the large-scale time-series information into memory as data frames and performs multiple stages of deterministic and heuristic preprocessing. The server applies missing-value completion by using algorithmic rules, such as forward filling for short gaps in time-series data, median imputation for numeric variables dominated by outliers, and model-based imputation for variables that exhibit nonlinear relationships. The server applies outlier removal by computing, for each numeric column, a robust dispersion metric (for example, median absolute deviation) and discarding or capping data points that exceed a predetermined multiple of this metric. The server normalizes selected continuous features by computing z-scores or by applying min-max scaling. The server aligns time stamps by resampling each series to a common time grid (for example, 1-hour or 1-day intervals) and by interpolating or aggregating values as needed. These specific operations reduce numerical instability and variance in input distributions, which in turn stabilizes gradient-based learning and improves convergence speed and prediction accuracy of downstream models.

The server calculates feature values, also referred to as candidate variable factors, by applying deterministic transformation functions to the preprocessed information set. The server computes moving averages over multiple window lengths (for example, 7 days, 14 days, 30 days) for operational counts to capture medium-term trends. The server computes change rates between adjacent periods, week-over-week rates, and month-over-month rates to quantify temporal change patterns. The server encodes seasonality by generating categorical indicators for day-of-week, holiday, or month-of-year and by representing these indicators as one-hot vectors. The server derives environment indicators by discretizing temperature into bins and generating binary flags for conditions such as heavy rain, extreme heat, or snow. The server generates economic indicators by computing first-order and second-order differences of indices and by classifying economic phases via thresholding.

The server executes correlation analysis and dimensionality reduction algorithms on the feature values. The server calculates correlation coefficients between each candidate feature and the target variable (for example, future workload or delivery volume) and eliminates features whose correlation magnitude is below a threshold. The server further applies a dimensionality reduction method, such as principal component analysis, to decorrelate features and reduce redundancy. The server determines variable factors as features or principal component scores that contribute above a predetermined percentage of explained variance and maintain sufficient mutual independence. The server stores the resulting group of variable factors in a columnar format in the database, indexed by time, region, and scenario, so that this group serves as a standardized, optimized representation of the state of the system.

The terminal acquires emotion-related data from the user. The terminal controls a camera to capture a sequence of images of the user’s face and controls a microphone to capture speech signals during interaction with the prediction system. The terminal preprocesses the captured images by normalizing resolution, face cropping, and grayscale or color normalization. The terminal preprocesses audio by performing voice activity detection and extracting spectral features such as mel-frequency cepstral coefficients. The terminal executes or invokes an emotion recognition algorithm, which may include a convolutional neural network for facial expression recognition and a recurrent neural network or Transformer network for prosodic pattern analysis, to classify the emotion state into one or more emotion labels, such as joy, anger, fatigue, or neutral, and to compute an emotion score vector representing confidence levels or intensities. The terminal packages the emotion state information together with a timestamp and optional scenario identifiers into a structured message and transmits it to the server via a secure communication protocol.

The server receives the emotion state information from the terminal and associates it with corresponding records in the group of variable factors. The server stores an emotion label and an emotion score vector as additional fields in the feature records. The server applies emotion-aware rules to modify or reweight existing variable factors. For example, when the emotion state indicates fatigue, the server multiplies variable factors related to maximum allowable workload per worker by a factor less than one, which later constrains resource allocation optimization. When the emotion state indicates joy, the server may slightly increase weight parameters for demand-increasing factors in a prediction model, subject to calibration constraints. This integration of emotion states inside the feature representation allows the machine learning model to learn and exploit correlations between human factors and workload patterns, which are often nonlinear and not easily captured by manual rules.

The server constructs and trains a machine learning model on the group of variable factors and historical target values. In one embodiment, the server constructs a recurrent neural network including multiple layers of long short-term memory units or gated recurrent units. The server defines an input layer whose dimension equals the number of variable factors plus the dimension of the emotion score vector. The server defines one or more hidden recurrent layers with specified numbers of units and activation functions, and an output layer that produces a continuous-valued prediction for future workload or delivery volume at one or more forecast horizons. In another embodiment, the server constructs a sequence model based on a Transformer architecture, in which the server applies self-attention mechanisms over the temporal dimension to capture long-range dependencies between time points and variable factors. The server uses a loss function such as mean squared error or mean absolute error to quantify prediction error on training data.

The server performs training using an optimization algorithm such as stochastic gradient descent with momentum or an adaptive method. The server uses mini-batch training where each batch consists of multiple time-series segments. The server implements early stopping, dropout, and weight regularization to mitigate overfitting. The server can optionally perform data augmentation by adding small amounts of noise or by slightly warping time indices in training sequences, thereby increasing robustness to measurement noise and timing variations. The server periodically evaluates the model on a validation set to monitor generalization performance and automatically adjusts hyperparameters such as learning rate, batch size, and number of layers within preconfigured ranges. This systematic learning process yields a machine learning model whose internal parameters encode complex nonlinear relationships among operational variables, environment variables, economic variables, and emotion states, thereby improving prediction accuracy compared to simple regression or rule-based models.

The server generates prediction information by applying the trained machine learning model to the latest feature records. The server composes input tensors from the group of variable factors and emotion state information for specified recent time windows and feeds these tensors into the model. The server obtains numerical predictions of workload or delivery volume for future time steps and stores these predictions as prediction information. Because the model takes into account preprocessed, decorrelated variable factors and emotion states, the predictions exhibit reduced noise, lower bias, and more accurate peak timing compared with predictions produced by conventional linear models.

The server generates a prompt sentence for a generative AI model by using a template mechanism. The server stores, in the database or configuration files, one or more templates that specify the structure of a natural-language prompt. Each template includes placeholders for numerical sequences of past values, descriptions of variable factors, emotion state indicators, and a description of the prediction task. The server converts selected sequences of historical workload or delivery volume into comma-separated lists, converts variable factor values and environment or economic indicators into short phrases, and converts emotion state information into text such as “current emotion state: joy” or “workers show high fatigue.” The server replaces the placeholders in the template with these natural-language fragments to assemble a coherent prompt sentence.

For example, the server can generate a prompt sentence as follows:

“Past 30 days of parcel arrival counts per day: 100, 120, 110, 130, 125, 140, 135, 150, 145, 160, 155, 170, 165, 180, 175, 190, 185, 200, 195, 210, 205, 220, 215, 230, 225, 240, 235, 250, 245, 260. Current emotion state: joy. Please predict the parcel arrival counts for each day of the next week and indicate the expected peak days and the main factors that contribute to those peaks.”

In another example, the server can generate a prompt sentence for a regional delivery volume task:

“Using the past 5 years of monthly delivery volume data, historical weather data (average temperature and precipitation), and monthly economic index values for this region, and given that workers’ current emotion state is fatigue, predict the delivery volume for next month and explain which factors most influence the forecast.”

The server inputs the generated prompt sentence to a generative AI model provided as a network service or hosted locally. The server constructs a request message containing the prompt sentence and configuration parameters such as maximum output length and sampling temperature. The server transmits this request via the network interface to the generative AI model and receives a natural-language response. The server parses the response by applying parsing rules and pattern-matching expressions to extract numerical predictions and explanatory sentences. The server converts the extracted results into structured data, including prediction result information (for example, forecasted values by day or hour) and factor explanations (for example, text indicating that rainy days or economic downturns increase or decrease workload). This structured extraction step ensures that the generative AI model’s output can be used systematically by other processor-controlled modules rather than being consumed solely by human readers.

The server formulates a resource allocation plan or schedule plan as an optimization problem. The server defines decision variables representing, for example, numbers of workers per shift, numbers of vehicles per route, assignment of workers to time slots, and machine operating hours. The server defines constraint conditions based on labor regulations, equipment capacities, maximum allowable workload per worker, minimum rest periods, and service-level targets. The server defines an objective function that minimizes a weighted combination of predicted overflow risk, labor cost, and workload imbalance. The server uses the prediction information and prediction result information as input data for parameters in the optimization problem. In particular, predicted peak workloads and predicted call volumes drive the lower bounds on required resources in each time slot.

The server executes an optimization solver, such as a linear programming or mixed-integer programming solver, to compute an optimal or near-optimal plan. The server adjusts constraints or weights based on emotion state information; for example, when fatigue is high, the server tightens constraints on maximum tasks per worker and increases penalties for highly concentrated workloads. Because the server encodes these conditions and objectives in a mathematical form and solves them algorithmically, the system achieves resource allocations that are both feasible and aligned with real-time predictions and human factors, in a way that would be difficult to achieve using manual heuristics.

The server converts the prediction information, prediction result information, and resource allocation or schedule plan into visualization information. The server constructs data structures that group time-indexed predictions into daily or hourly series, that group allocations per shift and region, and that associate each time segment with key metrics such as expected workload, assigned workers, and expected saturation level. The server populates fields for labels, numeric values, and explanatory annotations, suitable for rendering as line charts, bar charts, tables, or Gantt-style schedules on the terminal. The server exposes application programming interfaces that respond to requests from the terminal by returning this visualization information in a machine-readable format.

The terminal receives the visualization information from the server and presents it to the user. The terminal renders charts and tables that display predicted workload trajectories, expected peaks, and proposed resource allocations. The terminal also displays explanatory text extracted from the generative AI model output, such as statements identifying causes of predicted peaks. The terminal provides interactive controls that allow the user to select time ranges, regions, and scenarios, and to input corrections to emotion states or resource plans. The terminal sends scenario specification and plan correction input back to the server, where it is recorded and used as feedback.

The server implements a feedback loop by comparing prediction information and prediction result information with actual workload or delivery volume that is later stored as performance data. The server computes error indices, such as mean absolute error and percentage error, for each time period and scenario. The server also logs any plan correction information provided by the user, such as manual increases in staff for specific shifts or changes in vehicle deployment. The server uses this data to update the machine learning model, for example by retraining on expanded datasets containing more recent observations and by adjusting loss weights to penalize error patterns that lead to frequent manual corrections. The server also updates templates for prompt sentences, for example by adding or removing variable factors described in the text, or by amplifying instructions that reduce systematic biases in the generative AI model’s output. This continuous adaptation process contributes to reduced prediction error, improved stability, and better alignment between computed plans and actual operational needs.

By integrating specific data structures, defined preprocessing pipelines, emotion-aware feature modeling, mathematically formulated optimization, and structured interactions with a generative AI model, the system improves computer technology itself. The server reduces computational overhead by standardizing feature vectors and variable factors, which allows more efficient matrix operations and parallelization in neural network training. The server increases prediction accuracy and reduces error variance through decorrelation and dimensionality reduction, which improves conditioning of the learning problem. The server reduces communication load and improves reproducibility by generating prompt sentences according to templates, avoiding redundant contextual information and controlling prompt size. The server improves data management by maintaining consistent keys and feature schemas across operational, environment, economic, and emotion data. Because the system uses non-conventional combinations of feature engineering, neural architectures, optimization, and generative AI prompting, and because it embeds emotion information directly into the computational graph, the system provides a technical solution that goes beyond mere automation of manual planning tasks and leads to measurable improvements in speed, accuracy, and efficiency of computer-based prediction and scheduling.

In alternative embodiments, the server may employ different neural network architectures, such as convolutional neural networks for certain types of time-series, or hybrid models combining gradient-boosted decision trees with recurrent layers. The server may adjust the set of variable factors, for example by including sensor-derived machine health indicators or additional human factors. The server may use different optimization algorithms, such as heuristic meta-heuristics, when exact solvers are computationally expensive for large instances. The terminal may be implemented as a web browser application, a dedicated mobile application, or an embedded display in an industrial control system. In all cases, the server, the terminal, and the user cooperate within the same general framework of preprocessing large-scale time-series information, generating emotion-aware variable factors, invoking a generative AI model by means of structured prompt sentences, and computing and presenting optimized resource allocation plans that are continuously refined through feedback, thereby implementing the claimed invention.

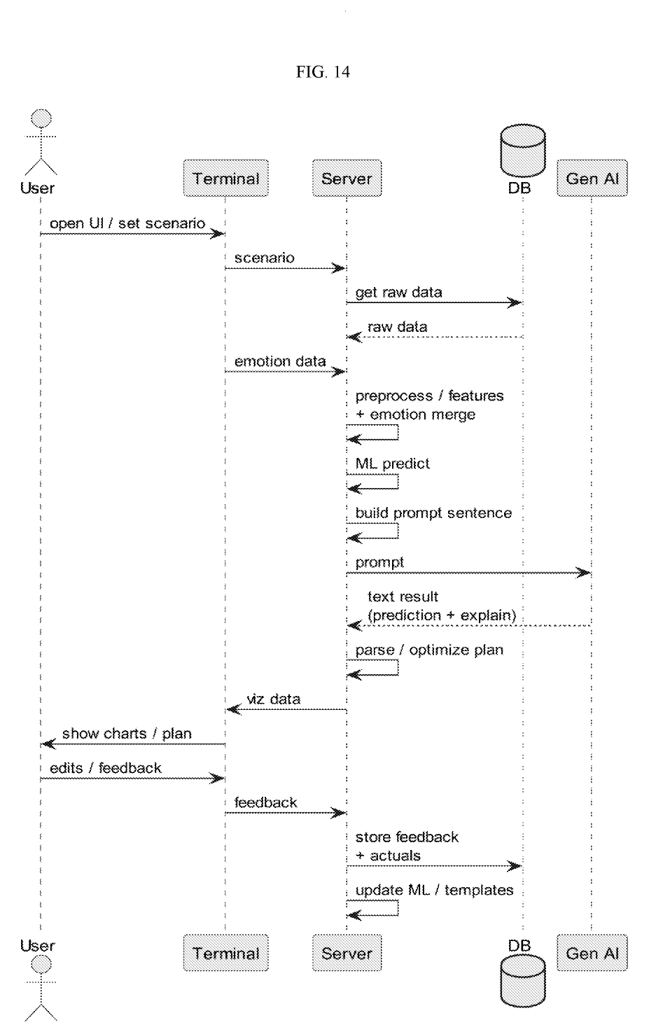

The following describes the processing flow using FIG. 14.

### Step 1

Server acquires raw data.

Server receives, as input, operational records (for example, arrival counts, delivery counts, call volumes, machine utilization logs, worker shift logs), environment records (for example, temperature, precipitation, weather type), and economic records (for example, economic indices, sales indices) from data storage systems and external information services. Server issues database queries through a database driver to fetch time-stamped rows and sends HTTP or similar requests through a network interface to external information providers. Server joins these heterogeneous records on common keys such as date, time, and region by performing relational joins and time alignment. Server outputs a unified raw dataset in a structured format, such as a time-indexed table or data frame.

### Step 2

Server preprocesses the unified raw dataset.

Server receives, as input, the unified raw dataset from Step 1. Server applies missing-value completion by scanning each column for null entries and filling them according to predefined rules, such as forward filling recent values for time-series gaps or replacing with median values for stable indicators. Server detects outliers by computing statistical measures, such as median absolute deviation or interquartile range, and flags rows whose values exceed configured thresholds; server then either removes these rows or caps anomalous values. Server normalizes numerical columns by computing mean and standard deviation or minimum and maximum and transforming each value into a standardized number. Server resamples and aligns time indices so that each time step has consistent intervals (for example, hourly or daily), aggregating higher-frequency data and interpolating lower-frequency data as necessary. Server outputs a preprocessed information set in which each row corresponds to a single time step with cleaned and normalized fields.

### Step 3

Server generates feature values and selects variable factors.

Server receives, as input, the preprocessed information set from Step 2. Server calculates moving averages over different window lengths (for example, last 7 days, last 30 days) by applying sliding-window aggregation along the time axis. Server computes change rates such as day-over-day, week-over-week, and month-over-month percentage differences by dividing differences of adjacent or offset time steps by the preceding values. Server encodes seasonality by generating indicator variables for day-of-week, holiday, or month-of-year and representing these as numerical or one-hot encoded vectors. Server derives environment indicators by discretizing continuous environment values into bins and generating binary flags for special conditions such as heavy rain or extreme temperatures. Server computes correlations between each candidate feature and target variables (for example, future workload) and may apply dimensionality reduction algorithms to capture principal components. Based on correlation thresholds and contribution to explained variance, server selects a subset of features as variable factors and groups them as a group of variable factors. Server outputs this group of variable factors along with a feature matrix aligned to the time index.

### Step 4

Terminal acquires emotion-related data and recognizes emotion.

Terminal receives, as input, user interaction context, including the current time and the relevant scenario (for example, shift planning session, delivery forecasting session). Terminal activates a camera to capture face images and a microphone to capture voice signals from the user during interaction. Terminal preprocesses image frames by cropping around detected faces and normalizing size and brightness, and preprocesses audio by segmenting speech and extracting spectral features. Terminal executes an emotion recognition algorithm, which may consist of a convolutional neural network for image features and a recurrent or Transformer-based network for audio features, to classify the emotion state into one or more labels (for example, joy, anger, fatigue) and to compute corresponding emotion scores. Terminal outputs emotion state information comprising at least one emotion label, a score vector, timestamps, and user or scenario identifiers, and transmits this information to the server through a communication channel.

### Step 5

Server integrates emotion state information with variable factors.

Server receives, as input, the emotion state information from Step 4 and the group of variable factors from Step 3. Server matches emotion records to feature records by aligning timestamps and scenario identifiers, and then writes emotion labels and score vectors into additional columns of the feature matrix. Server applies emotion-based adjustment rules, for example, by multiplying workload capacity-related variable factors by a coefficient less than one when fatigue scores exceed a threshold or by adjusting weights of demand-sensitive factors when joy scores are high. Server thereby generates an emotion-augmented feature matrix, in which the group of variable factors includes both original features and emotion-sensitive modifications. Server outputs this emotion-augmented feature matrix for model training or inference.

### Step 6

Server trains a machine learning model for workload or delivery prediction.

Server receives, as input, historical segments of the emotion-augmented feature matrix and corresponding actual workload or delivery volumes as target values. Server partitions the data into training, validation, and test sets according to time. Server constructs a neural network architecture, for example, a recurrent model with multiple layers of long short-term memory units or a Transformer model with self-attention layers. Server defines an input layer whose dimension equals the number of variable factors plus the dimension of emotion scores, defines hidden layers with configured numbers of units and activation functions, and defines an output layer that outputs predicted values at selected forecast horizons. Server selects a loss function (for example, mean squared error) and an optimization algorithm (for example, stochastic gradient descent or an adaptive gradient method). Server repeatedly feeds batches of input sequences and target values into the model, computes gradients of the loss with respect to weights, and updates the weights according to the optimization algorithm. Server monitors validation loss and implements regularization techniques, such as dropout and early stopping, to prevent overfitting. Server outputs a trained machine learning model whose parameters are stored in a model repository.

### Step 7

Server generates prediction information using the trained machine learning model.

Server receives, as input, the latest emotion-augmented feature matrix for a recent time window and the trained machine learning model from Step 6. Server constructs input tensors by stacking feature vectors for each time step in the window and arranges them according to the required model input shape. Server performs a forward pass of the model without updating weights, computing predicted workload or delivery values for one or more future time steps. Server may post-process the raw outputs by clipping negative values to zero, aggregating forecasts over longer intervals (for example, from hourly to daily), or smoothing minor fluctuations. Server outputs prediction information in the form of a time-indexed table of predicted values, associated confidence scores if available, and identifiers for region and scenario.

### Step 8

Server constructs a prompt sentence for a generative AI model.

Server receives, as input, the group of variable factors, the emotion state information, and the prediction information from Steps 3, 5, and 7. Server selects relevant segments of historical values, such as past 30 days of arrival counts or past 12 months of delivery volumes, and formats them as numerical sequences embedded in text. Server reads a stored template that includes placeholders for data sequences, emotion description, and task description. Server replaces placeholders with actual values, such as lists of numbers, phrases describing environment and economic conditions, and explicit mention of the current emotion state. Server also inserts the forecast horizon and the type of target (for example, daily parcel arrival counts, hourly call volumes, next month’s total delivery volume). Server assembles these parts into a coherent natural-language prompt sentence. Server outputs the completed prompt sentence ready for input to a generative AI model.

### Step 9

Server queries the generative AI model and parses its output.

Server receives, as input, the prompt sentence from Step 8. Server constructs a request object containing the prompt sentence and generation parameters such as maximum output length and desired level of determinism. Server transmits the request to a generative AI model implementation, either hosted locally or accessible via a network API, and waits for an output text. Server receives, as output from the generative AI model, a natural-language passage containing predicted numerical values, qualitative assessments, and explanations of contributing factors. Server applies parsing routines that scan the text for patterns corresponding to numbers and time references, for example, phrases like “Day 1: 120, Day 2: 130,” and maps these to structured prediction entries. Server separates explanatory sentences, such as descriptions of the influence of weather or economic changes, and stores them as explanation fields. Server outputs prediction result information, including parsed forecast values and associated natural-language explanations in a structured format.

### Step 10

Server computes a resource allocation plan or schedule plan.

Server receives, as input, prediction information from Step 7 and prediction result information from Step 9. Server defines decision variables representing, for example, numbers of workers assigned to each time slot, numbers of vehicles allocated to each route, and operating states (on/off) of each facility resource. Server defines constraint conditions using stored parameters such as maximum working hours, minimum rest requirements, equipment capacity limits, and required service levels. Server formulates an objective function that minimizes a weighted sum of labor costs, underutilization, and predicted overload risk. Server constructs a formal optimization model using these variables, constraints, and objective, and then executes an optimization algorithm (for example, linear programming or mixed-integer programming). Server evaluates candidate solutions and selects one that satisfies all constraints while optimizing the objective. Server then adjusts the solution if emotion state information indicates high fatigue or stress by tightening per-worker workload limits or adding rest periods. Server outputs a resource allocation plan or schedule plan specifying assignments per time slot, resource usage, and any inserted breaks.

### Step 11

Server prepares visualization information for terminal display.

Server receives, as input, the prediction information, prediction result information, and resource or schedule plan from Steps 7, 9, and 10. Server reorganizes prediction values into series grouped by day, hour, or shift, and joins them with plan information such as assigned workers and vehicles. Server attaches explanatory text segments from the generative AI model output to relevant time ranges, for example, labeling predicted peaks with their described causes. Server constructs data structures containing arrays of timestamps, numerical values, labels, and annotations suitable for visualization components such as line charts, bar charts, and Gantt-style diagrams. Server outputs visualization information and makes it available through an interface that the terminal can call.

### Step 12

Terminal displays visualization information and collects user input.

Terminal receives, as input, visualization information from Step 11. Terminal renders predicted workload or delivery volume curves, proposed staffing levels, and resource allocations on a display, using graphical widgets such as charts and tables. Terminal also displays explanatory text near corresponding graphical elements to convey the reasoning behind predicted peaks or troughs. Terminal presents interactive controls allowing the user to select different time ranges, regions, or scenarios, and to edit parts of the resource allocation plan by, for example, increasing the number of workers in a specific shift or changing vehicle assignments. Terminal captures user edits and scenario selections as plan correction input and scenario specification data, and transmits them as structured messages to the server. Terminal outputs these user inputs for further processing.

### Step 13

Server incorporates user feedback and updates models and templates.

Server receives, as input, plan correction input and scenario specification from Step 12, along with later-acquired actual workload or delivery volumes recorded in the database as performance data. Server compares the original prediction information and prediction result information with the actual performance data to compute error indices, such as mean absolute error and percentage error over different forecast horizons. Server compares the automatically generated plan with the user-corrected plan to derive plan correction information, representing where and how the original plan was modified. Server records these error indices and plan correction information in a dedicated feedback store. Server periodically uses this feedback store to retrain or fine-tune the machine learning model by extending the training dataset and modifying the loss weighting to emphasize error-prone regions. Server also updates templates for prompt sentences by adjusting which variable factors are included or how instructions to the generative AI model are phrased, guided by patterns detected in the feedback. Server outputs updated model parameters and revised prompt sentence templates, thereby refining future prediction and planning behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

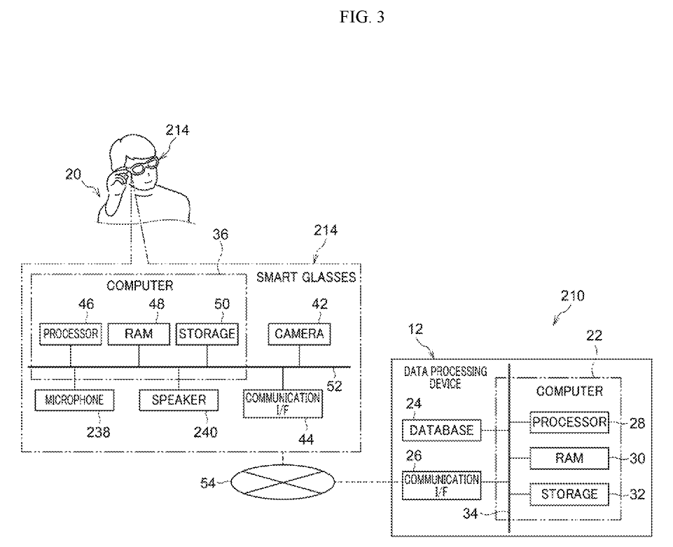

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

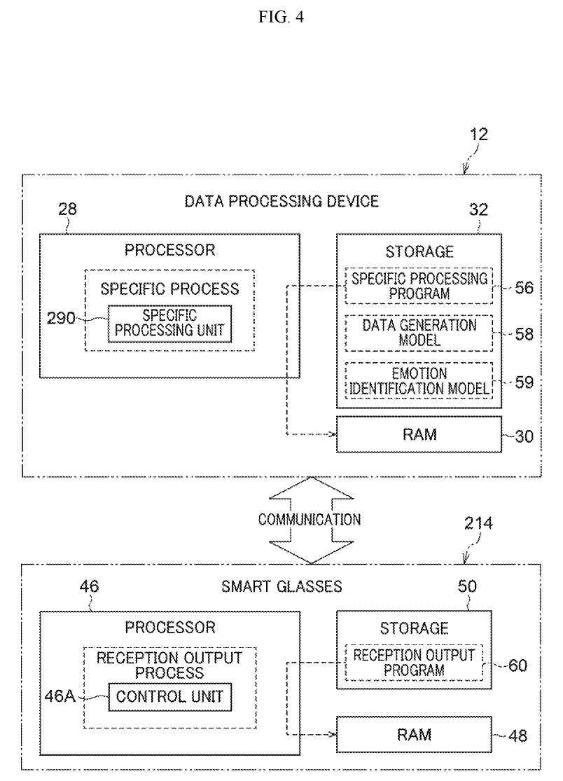

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

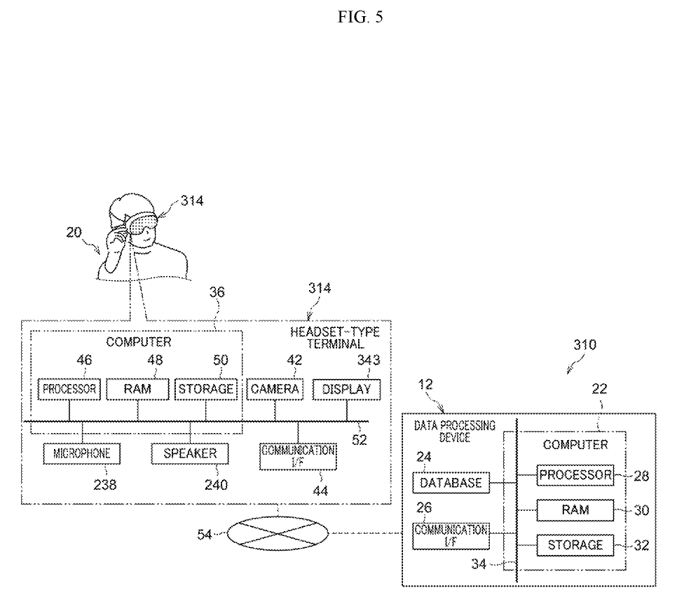

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

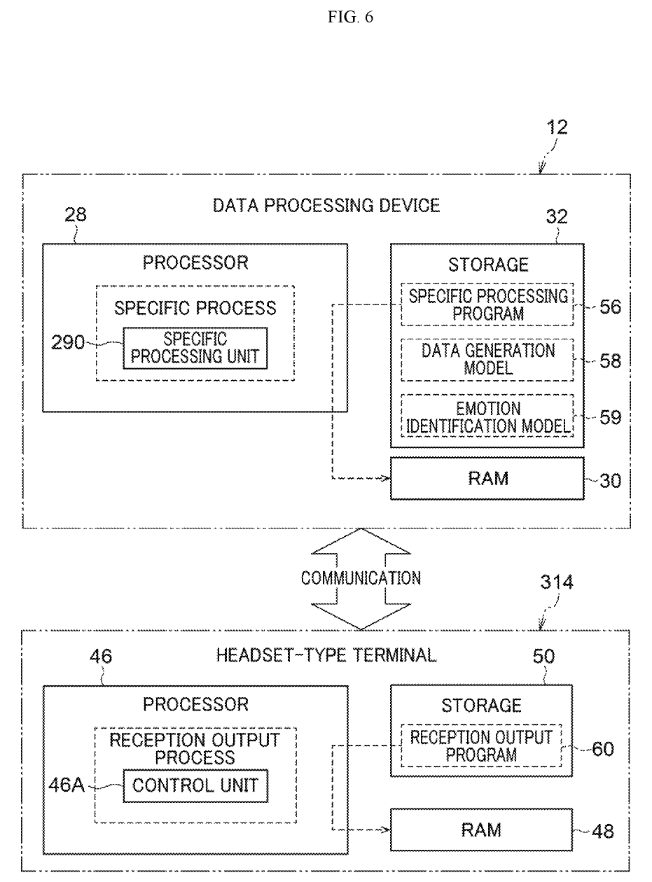

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

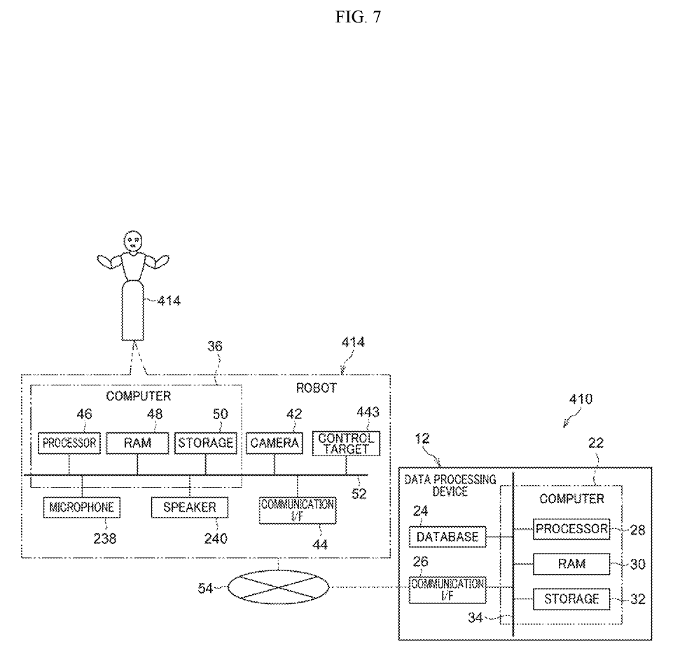

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

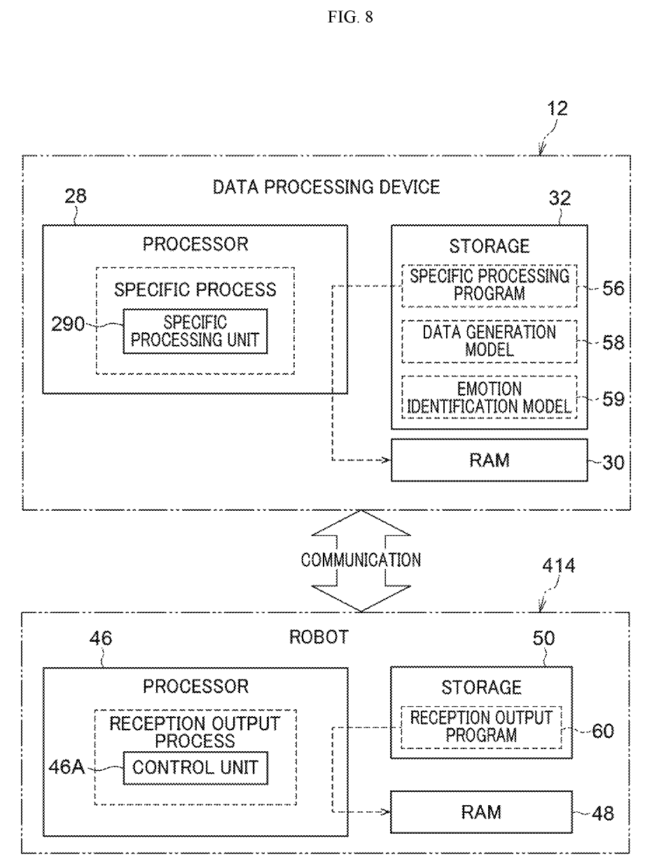

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

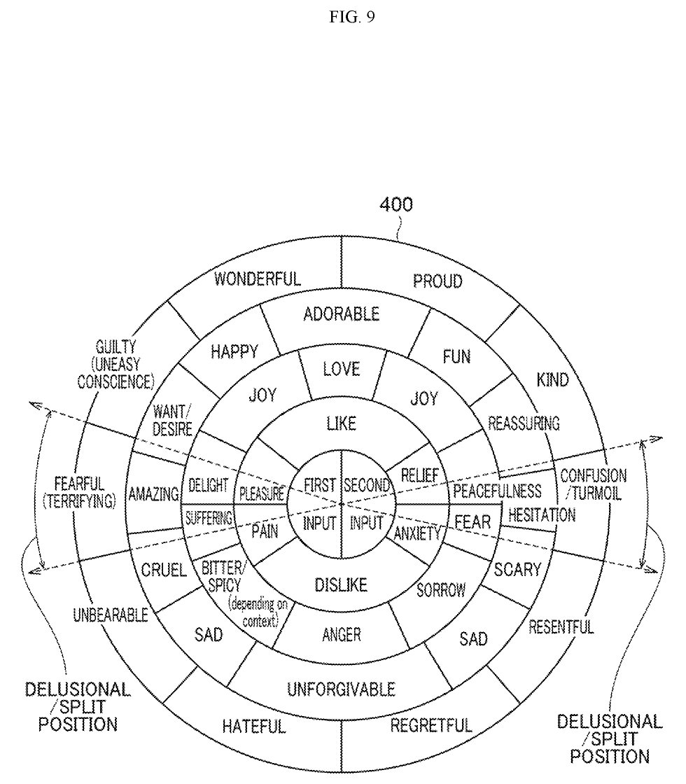

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

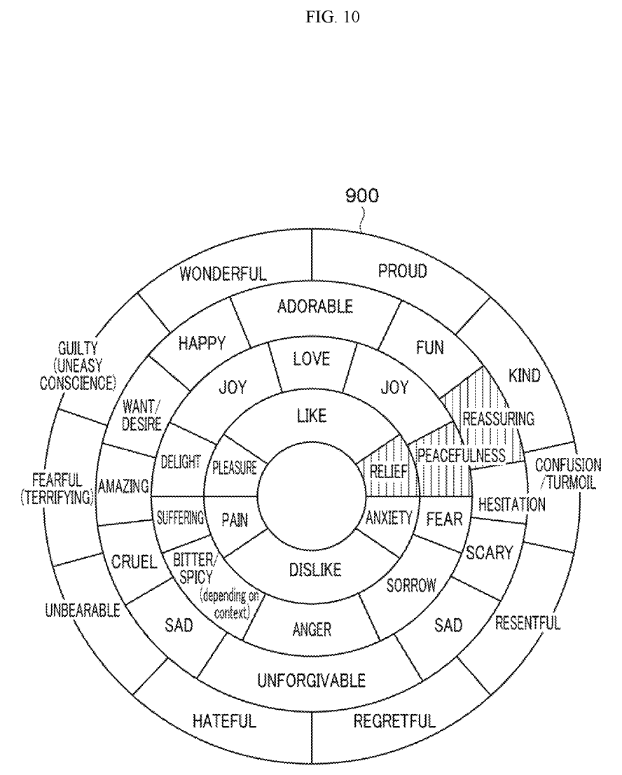

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

acquire large-scale information including past business-related information, external environment-related information, and economic condition-related information, and preprocess the large-scale information to generate training input information; and

train a multilayer numerical computation model using the training input information, execute optimization processing based on gradients on the multilayer numerical computation model, and thereby generate an estimation model configured to output variable factors that affect a business activity amount; and

input latest business-related information, external environment-related information, and economic condition-related information into the estimation model, and generate, by computation, variable factors relating to a future business activity amount; and

construct, based on the generated variable factors and forecast target conditions, a prompt sentence as an instruction text to be input to a generative AI model; and

input the prompt sentence to the generative AI model, and obtain, from the generative AI model, a prediction result including descriptive information or numerical information relating to the future business activity amount; and

generate, from the prediction result, detailed prediction information including an increase or decrease of the business activity amount and a temporal peak, and format the detailed prediction information as display information or output information; and

acquire state information of a user and adjust at least one of the prediction result and the detailed prediction information based on the state information of the user.

### Supplementary 2

The system according to supplementary 1,

wherein the processor is configured to use a deep learning model as the multilayer numerical computation model, and to execute numerical optimization processing using a numerical matrix computation library in training the deep learning model and in generating the variable factors.

### Supplementary 3

The system according to supplementary 1,

wherein the processor is configured to specify, via the prompt sentence, an output format as structured information for the generative AI model, to analyze the structured information obtained from the generative AI model, to extract a business activity amount for each time unit, a peak time, and explanatory information for factors of the peak time, and to output the extracted information as electronic information for business planning.

### Application Example 1

### Supplementary 1

A system comprising a processor,

wherein the processor is configured to

acquire past operational information and external environment information from an information storage device storing the past operational information and the external environment information, and

preprocess the acquired past operational information and the external environment information to generate variable factors including time-series indices, aggregated quantities, moving averages, seasonality indices, and external factor indices, and

transmit the generated variable factors and prediction conditions as structured data to a generative information processing apparatus, and

input the variable factors as input features into a generative learning model including a deep learning model, and generate workload prediction information including future inbound quantities, outbound quantities, and inventory quantities, and

calculate a personnel allocation plan and an inventory management plan based on the workload prediction information, and

generate display information including the workload prediction information, the personnel allocation plan, and the inventory management plan, and output the display information to a display device, and

generate a prompt sentence including a summary of the workload prediction information and the variable factors, and input the prompt sentence into a generative learning model that performs natural language generation processing to generate an explanatory text or a recommendation text, and

output the explanatory text or the recommendation text to the display device to support a user in making an operational planning decision.

### Supplementary 2

The system according to supplementary 1,

wherein the processor is configured to

use a machine learning algorithm in the generation of the variable factors to automatically extract the variable factors from the past operational information and the external environment information, and repeatedly execute the generative learning model for a plurality of scenario conditions to generate a plurality of types of workload prediction information.

### Supplementary 3

The system according to supplementary 1,

wherein the processor is configured to

configure an optimization model using the workload prediction information as demand constraints in calculating the personnel allocation plan and the inventory management plan, solve the optimization model to derive a planning proposal including a number of personnel, work assignments, and order quantities, and present key points and risk information of the planning proposal within the explanatory text or the recommendation text.

### Example 2

### Supplementary 1

A system comprising a processor,

wherein the processor is configured to

store large-scale information in an information storage unit, and

acquire historical information stored in the information storage unit, construct a prompt sentence for generating an information processing program, input the prompt sentence into a generative AI model, and acquire, from the generative AI model, the information processing program that executes variable factor generation processing and future workload prediction processing based on the historical information, and

execute the information processing program to perform, by a statistical processing unit, preprocessing on the historical information including missing-value completion processing and outlier processing, generate variable factors from the historical information including time information, statistical information, and external condition information, and store the variable factors as a group of features in a data structure, and

input, into the generative AI model, the variable factors generated by the information processing program and a prompt sentence including prediction conditions, and calculate, by using the generative AI model or a machine learning program generated by the generative AI model, a prediction result including a time transition of future workload, an increase/decrease trend of the workload, and peak time periods, and

input the prediction result into a visualization processing program, execute the visualization processing program to generate, based on the prediction result, image information including a graph along a time axis, a category-based bar graph, or a time-period-based density representation, and cause an output device to display the image information, and

acquire operation information of a user and emotional state information of the user with respect to the displayed prediction result, construct a prompt sentence including an adjustment condition based on the operation information and the emotional state information, re-input the prompt sentence into the generative AI model, and update contents of the prediction result calculated by the prediction result calculation using an updated output of the generative AI model.

### Supplementary 2

The system according to supplementary 1,

wherein the processor is configured to

execute the machine learning program generated by the generative AI model, construct a learning model that performs learning processing based on the variable factors and the historical information, and output, by using the learning model, a numerical sequence of future workload.

### Supplementary 3

The system according to supplementary 1,

wherein the processor is configured to

generate, by the visualization processing program, visualization information indicating a workload distribution per day or per time unit in a future period based on the prediction result, and change, based on the emotional state information of the user, at least one of emphasis display of peak time periods in the visualization information and contents of a proposal of resource allocation.

### Application Example 2

### Supplementary 1

A system comprising a processor,

wherein the processor is configured to

acquire, for workload prediction or delivery volume prediction, large-scale time-series information including operational information, environment information, and economic information, and perform preprocessing on the large-scale time-series information including missing-value completion, outlier removal, normalization, and time-series alignment to generate a preprocessed information set; and

calculate, from the preprocessed information set, feature values including moving averages, change rates, seasonality indicators, and environment indicators, perform correlation analysis or dimensionality reduction analysis on the feature values, identify variable factors that influence the workload or the delivery volume based on a result of the analysis, and store the identified variable factors as a group of variable factors; and

obtain an emotion state of a user by analyzing emotion-related data acquired from an image input device or a sound input device with an emotion recognition algorithm, generate emotion state information as an emotion label or an emotion score including at least one of joy, anger, and fatigue, and record the emotion state information as additional information in association with the group of variable factors; and

construct a machine learning model by learning a relationship between past workload or delivery volume and future workload or delivery volume based on the group of variable factors and the emotion state information, and generate prediction information by numerically estimating the future workload or the future delivery volume at a future time using the machine learning model; and

generate a prompt sentence for input to a generative AI model by formatting explanation input information, including the group of variable factors, the emotion state information, and the prediction information, into a natural-language form and describing past information sequences, the emotion state, and a prediction target; and

input the prompt sentence to an internal or external generative AI model, analyze a natural-language output obtained from the generative AI model, extract prediction result information including prediction values relating to the future workload or the future delivery volume and explanatory information regarding factors of the prediction values, and convert the prediction result information into structured data; and

formulate a resource allocation plan or a schedule plan, including worker numbers, work time zones, transportation means numbers, and facility operation states, as an optimization problem based on the prediction information and the prediction result information, calculate the resource allocation plan or the schedule plan based on constraint conditions and evaluation indices, and perform adjustment including load reduction or insertion of rest periods according to the emotion state information; and

convert the prediction information, the prediction result information, and the resource allocation plan or the schedule plan into visualization information in which indices are arranged by time axis, area, and work unit, transmit the visualization information to a terminal device for display, obtain scenario specification, emotion state correction, or plan correction input from the user via the terminal device, and reflect the input in the prediction information and the resource allocation plan or the schedule plan.

### Supplementary 2

The system according to supplementary 1,

wherein the processor is configured to

hold a template for the prompt sentence for input to the generative AI model, the template including placeholders for inserting time-series information including the group of variable factors and the emotion state information as human-readable numerical sequences and descriptive text, and dynamically construct the prompt sentence, which simultaneously includes a prediction request and a factor-explanation request, by replacing the placeholders with concrete values corresponding to the group of variable factors, the emotion state information, and a prediction target period.

### Supplementary 3

The system according to supplementary 1,

wherein the processor is configured to

calculate error indices between the prediction information and the prediction result information and actual workload or delivery volume acquired as performance data, record plan correction information provided by the user via the terminal device as additional learning data, and periodically update the machine learning model and the template for generation of the prompt sentence using the error indices and the plan correction information so as to improve future prediction accuracy and a degree of fit of the resource allocation plan.

What is claimed is:

1. A system comprising:
circuitry configured to:
receive, via a communication interface coupled to a packet-switched network, large-scale input data from one or more data sources, the input data including past operational data, external environment data, and economic condition data, and store the input data in a storage device;
preprocess the input data to generate training input data, train a multilayer computational model using the training input data, and input variable factors extracted by the computational model as a prompt sentence to a generative AI model to obtain a prediction result; and
recognize an emotional state of a user based on data received from a terminal device via the communication interface, adjust the prediction result based on the recognized emotional state, and transmit the adjusted prediction result to the terminal device via the communication interface.

2. The system according to claim 1, wherein the circuitry is configured to
perform data cleaning, normalization, and feature transformation on the input data as part of preprocessing to generate the training input data.

3. The system according to claim 2, wherein the circuitry is configured to
train the multilayer computational model using the training input data to generate variable factors representing influential patterns in the input data, and store the trained model parameters in the storage device.

4. The system according to claim 3, wherein the circuitry is configured to
generate a prompt sentence incorporating the variable factors extracted by the trained multilayer computational model, input the prompt sentence to the generative AI model, and obtain from the generative AI model a prediction result including at least a predicted increase or decrease in workload and a peak time of the workload.

5. The system according to claim 4, wherein the circuitry is configured to
further adjust the prediction result based on the recognized emotional state of the user, and modify at least one of a presentation format, a content emphasis, and a confidence threshold of the prediction result based on the recognized emotional state.

6. The system according to claim 1, wherein the circuitry is configured to
receive the large-scale input data from a plurality of storage devices or communication interfaces including at least historical operational data and external environment data, and aggregate the received data in the storage device prior to preprocessing.

7. The system according to claim 6, wherein the circuitry is configured to
identify latent variable factors representing patterns in the input data using the multilayer computational model, and generate a structured representation of the latent variable factors for use as a prompt to the generative AI model.

8. The system according to claim 1, wherein the circuitry is configured to
recognize the emotional state of the user by applying an emotion analysis engine to at least one of text data, vocal characteristics, and behavioral data received from the terminal device via the communication interface.

9. The system according to claim 8, wherein the circuitry is configured to
modify the adjustment applied to the prediction result based on a magnitude or polarity of the recognized emotional state of the user.

10. The system according to claim 1, wherein the circuitry is configured to
continuously update the multilayer computational model based on newly received input data and feedback received from the terminal device, and store updated model parameters in the storage device.

11. The system according to claim 10, wherein the circuitry is configured to
regenerate variable factors using the updated multilayer computational model, generate a new prompt sentence incorporating the regenerated variable factors, and obtain an updated prediction result from the generative AI model.

12. The system according to claim 1, wherein the circuitry is configured to
generate a detailed prediction result including at least a predicted metric value, a trend direction, and a time-of-peak indicator based on output of the generative AI model, and transmit the detailed prediction result to the terminal device.

13. The system according to claim 12, wherein the circuitry is configured to
format the detailed prediction result as structured data suitable for display, and adjust the format of the structured data based on the recognized emotional state of the user prior to transmission to the terminal device.

14. The system according to claim 1, wherein the circuitry is configured to
apply a feedback loop in which usage data received from the terminal device is incorporated into retraining of the multilayer computational model, thereby enabling the model to evolve based on observed prediction outcomes.

15. The system according to claim 14, wherein the circuitry is configured to
schedule periodic retraining of the multilayer computational model based on accumulated input data and feedback data stored in the storage device.

16. The system according to claim 1, wherein the circuitry is configured to
generate multiple prediction scenarios by varying input parameters to the generative AI model, and present a ranked set of prediction scenarios to the terminal device based on relevance scores computed from the variable factors.

17. The system according to claim 16, wherein the circuitry is configured to
select a prediction scenario for presentation based on the recognized emotional state of the user, prioritizing scenarios with a presentation format aligned with the user's current state.

18. A system comprising:
circuitry configured to:
receive, via a communication interface coupled to a packet-switched network, large-scale input data from one or more data sources and store the input data in a storage device;
preprocess the input data to generate training input data, train a multilayer computational model, extract variable factors from the trained model, generate a prompt sentence incorporating the variable factors, and input the prompt sentence to a generative AI model to obtain a prediction result;
recognize an emotional state of a user based on data received from a terminal device via the communication interface, and adjust the prediction result based on the recognized emotional state; and
transmit the adjusted prediction result to the terminal device via the communication interface, and update the multilayer computational model based on feedback received from the terminal device.

19. The system according to claim 18, wherein the circuitry is configured to
continuously receive updated input data via the communication interface, regenerate variable factors using the updated multilayer computational model, and generate updated prediction results incorporating the regenerated variable factors.

20. A method comprising:
receiving, via a communication interface coupled to a packet-switched network, large-scale input data from one or more data sources and storing the input data in a storage device;
preprocessing the input data to generate training input data, training a multilayer computational model using the training input data, and inputting variable factors extracted by the computational model as a prompt sentence to a generative AI model to obtain a prediction result; and
recognizing an emotional state of a user based on data received from a terminal device via the communication interface, adjusting the prediction result based on the recognized emotional state, and transmitting the adjusted prediction result to the terminal device via the communication interface.
